(19) United States
(12) Patent Application Publication
(10) Pub. No.: US 2022/0404725 A1
(43) Pub. Date: Dec. 22, 2022

(54) IMAGE FORMING METHOD, PROCESS CARTRIDGE, AND IMAGE FORMING APPARATUS

(71) Applicant: CANON KABUSHIKI KAISHA, Tokyo (JP)

(72) Inventors: Haruhiko Mitsuda, Chiba (JP); Ryoichi Tokimitsu, Chiba (JP); Takeshi Hashimoto, Ibaraki (JP)

(21) Appl. No.: 17/834,317

(22) Filed: Jun. 7, 2022

(30) Foreign Application Priority Data
Jun. 9, 2021 (JP) 2021-096905

(51) Int. Cl. G03G 5/147; G03G 9/087

(52) U.S. Cl. CPC G03G 5/14726; G03G 9/08728

(57) ABSTRACT

An image forming method includes a charging step, an image exposure step, a developing step, a transferring step, a cleaning step, and a fixing step. A toner contains toner particles, the toner particles contain a resin A including a unit A1 including an alkyl group having 18 to 36 carbon atoms in the side chain, and the electrophotographic photoreceptor includes a surface layer containing (i) fluorine-containing resin particles and (ii) a fluorine-based polymer B.

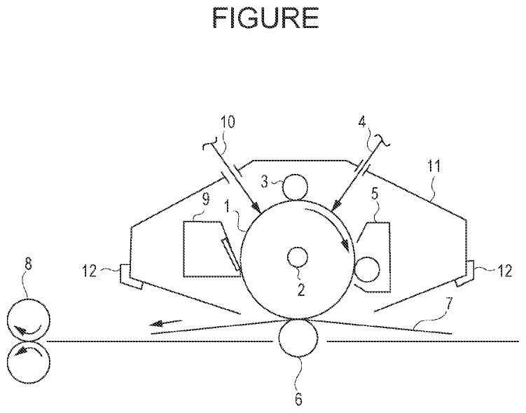

### BACKGROUND OF THE INVENTION

### Field of the Invention

The present disclosure relates to an image forming method, a process cartridge, and an image forming apparatus.

### Description of the Related Art

Recently, as an organic electrophotographic photoreceptor (hereinafter, referred to as “electrophotographic photoreceptor”), an electrophotographic photoreceptor having a surface layer containing fluorine resin-containing resin particles has been proposed. For example, Japanese Patent Laid-Open No. 2013-200418 discloses that an electrophotographic photoreceptor having an excellent image quality maintainability can be obtained by a surface layer containing fluorine-based resin microparticles and a fluorinated alkyl group-containing copolymer including a specific unit.

In addition, recently, in order to reduce the amount of energy used by an image forming apparatus, there is a demand for a toner that can be fixed at low temperatures. For example, Japanese Patent Laid-Open No. 2007-193069 discloses that a toner having excellent low-temperature fixability can be obtained by a crystalline resin that is a polyalkyl (meth)acrylate having an alkyl group having 18 or more carbon atoms and includes a carboxyl group-containing monomer at a rate of 10 to 50 mol %.

However, as the results of studies by the present inventors, it was found that image streaks are likely to be generated in output images in some cases by forming the images using a toner containing a polyalkyl (meth)acrylate having a long-chain alkyl group and the electrophotographic photoreceptor described in Japanese Patent Laid-Open No. 2013-200418.

### SUMMARY OF THE INVENTION

One aspect of the present disclosure is to provide an image forming method that is unlikely to form image streaks in output images.

Another aspect of the present disclosure is to provide a process cartridge that is used in the image forming method according to the present disclosure.

Another aspect of the present disclosure is to provide an image forming apparatus that is used in the image forming method according to the present disclosure.

According to an aspect of the present disclosure, provided is an image forming method including a charging step of charging a surface of an electrophotographic photoreceptor, an image exposure step of irradiating the charged surface of the electrophotographic photoreceptor with image exposure light to form an electrostatic latent image on the surface of the electrophotographic photoreceptor, a developing step of developing the electrostatic latent image with a toner to form a toner image on the surface of the electrophotographic photoreceptor, a transferring step of transferring the toner image from the surface of the electrophotographic photoreceptor onto a transfer material, a cleaning step of removing the toner remaining on the surface of the electrophotographic photoreceptor with a cleaning blade after the transferring step, and a fixing step of fixing the toner image transferred to the transfer material to the transfer material. The toner contains toner particles, and the toner particles contain a resin A including a unit A1 represented by formula (1):

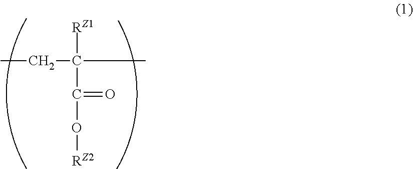

where R^{Z1} represents a hydrogen atom or a methyl group, and R^{Z2} represents an alkyl group having 18 to 36 carbon atoms. The electrophotographic photoreceptor includes a surface layer containing (i) fluorine-containing resin particles and (ii) a fluorine-based polymer B including a unit B1 represented by formula (2) and a unit B2 represented by formula (3):

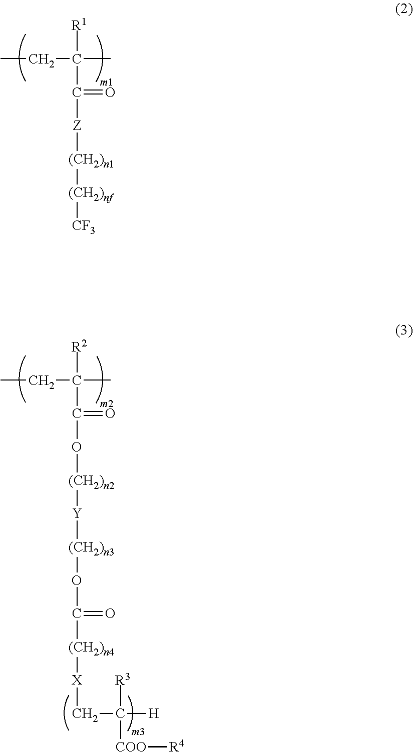

where R¹, R², R³, and R⁴ each independently represent a hydrogen atom or an alkyl group; X represents an alkylene group, a halogen-substituted alkylene group, —S—, —O—, —NH—, or a single bond; Y represents an alkylene group, a halogen-substituted alkylene group, an alkylene group including a hydroxy group, or a single bond; Z represents —O— or —NH—; m1, m2, and m3 each independently represent an integer of 1 or more; n1, n2, n3, and n4 each independently represent an integer of 0 or more; and of represents an integer of 1 to 5.

According to another aspect of the present disclosure, provided is a process cartridge that is attachable to and detachable from an electrophotographic apparatus main body. The process cartridge integrally supports at least one device selected from the group consisting of a charging device, an exposing device, a developing device, a transferring device, and a cleaning device. The process cartridge includes a toner according to the present disclosure and an electrophotographic photoreceptor according to the present disclosure.

According to another aspect of the present disclosure, provided is an image forming apparatus including a charging device, an exposing device, a developing device, a transferring device, a fixing device, and a cleaning device. The image forming apparatus includes a toner according to the present disclosure and an electrophotographic photoreceptor according to the present disclosure.

Further features of the present disclosure will become apparent from the following description of exemplary embodiments with reference to the attached drawing.

### BRIEF DESCRIPTION OF THE DRAWINGS

FIGURE shows an example of a schematic structure of an electrophotographic apparatus provided with a process cartridge including an electrophotographic photoreceptor of the present disclosure.

### DESCRIPTION OF THE EMBODIMENTS

In the present disclosure, the description of “xx or more and yy or less” and “xx to yy” indicating a numerical range means a numerical range including a lower limit and an upper limit which are end points, unless otherwise specified. In the present disclosure, “(meth)acrylic” means acrylic and/or methacrylic, and “(meth)acrylate” means acrylate and/or methacrylate.

As described above, a toner having excellent low-temperature fixability is likely to be obtained by that the toner contains a polyalkyl (meth)acrylate having a long-chain alkyl group. In addition, the present inventors examined the toner and as a result, found that the slipperiness of the toner is likely to increase. The present inventors infer that the slipperiness of the toner is increased by that in the polyalkyl (meth)acrylate having a long-chain alkyl group, the aggregation of long-chain alkyl groups present in the site-chain parts of the polymer facilitates formation of dense crystalline sites.

The present inventors found that when an image is formed using a toner containing the polyalkyl (meth)acrylate having a long-chain alkyl group and an electrophotographic photoreceptor described in Japanese Patent Laid-Open No. 2013-200418, image streaks are likely to be generated in some cases. The present inventors speculate the reasons as follows.

It is inferred that when image output is performed using an electrophotographic photoreceptor including a surface layer containing fluorine-based resin particles and a fluorinated alkyl group-containing copolymer described in Japanese Patent Laid-Open No. 2013-200418, the fluorinated alkyl group-containing copolymer may be partially scraped by and adhere to a cleaning blade in some cases. It is inferred that, as a result, the slipperiness between the cleaning blade and the surface layer of the electrophotographic photoreceptor is likely to be increased by the fluorinated alkyl group-containing copolymer having high slipperiness. In this state, if the toner having high slipperiness is used, it is inferred that the toner is likely to easily pass through between the cleaning blade and the surface layer of the electrophotographic photoreceptor, and the present inventors speculate that the passed-through toner causes image streaks. From the viewpoint of easily obtaining high-quality images, necessarily, the image forming method is required to be a method that does not easily cause image streaks, and it was recognized that improvement in this regard is necessary.

Based on the above consideration, the present inventors investigated an image forming method that is unlikely to cause image streaks even when a toner containing a polyalkyl (meth)acrylate having a long-chain alkyl group and an electrophotographic photoreceptor including a surface layer containing a fluorinated alkyl group-containing copolymer were used. As a result, it was found that when the number of carbon atoms of the fluorinated alkyl group of the fluorinated alkyl group-containing copolymer and the number of carbon atoms of the long-chain alkyl group of the polyalkyl (meth)acrylate are set within specific ranges, it is effective as an image forming method having the above-mentioned characteristics. The present inventors speculate that when the numbers of carbon atoms of the fluorinated alkyl group and the long-chain alkyl group are set within specific ranges, the slipperiness between the surface layer and the cleaning blade and the slipperiness of the toner are unlikely to excessively increase, and image streaks due to passing through of the toner are unlikely to be caused.

Toner

The toner according to the present disclosure contains toner particles, and the toner particles contain a resin A including a unit A1 represented by the following formula (1):

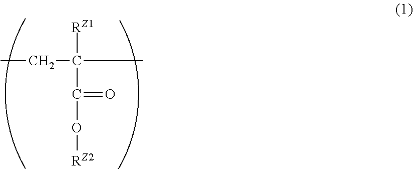

(in the formula (1), R^{Z1} represents a hydrogen atom or a methyl group, and R^{Z2} represents an alkyl group having 18 to 36 carbon atoms).

### Resin A and Unit A1

The resin A according to the present disclosure includes a unit A1 represented by the formula (1). Since the unit A1 includes an alkyl group having 18 to 36 carbon atoms represented by R^{Z2} in the side chain, it is inferred that the alkyl groups aggregate to facilitate formation of a crystalline site, and the crystallinity of the resin A is likely to increase. The present inventors infer that due to ease of facilitation of the crystallinity of the resin A, the slipperiness of the toner containing the resin A is likely to increase.

Since the crystallinity of the resin A is likely to increase, the resin A is likely to have a sharp melt property, and the toner is likely to have a low softening point. According, the toner containing the resin A is likely to be a toner having excellent low-temperature fixability. The unit A1 according to the present disclosure may be a single unit or a combination of two or more units.

When the number of carbon atoms of R^{Z2} in the formula (1) is 18 or more, the resin A is likely to have a sharp melt property, and the softening point of the toner is likely to be low. Accordingly, the toner containing the resin A is likely to be a toner having excellent low-temperature fixability. It is inferred that when the number of carbon atoms of R^{Z2} is 36 or less, the slipperiness of the toner containing the resin A is unlikely to excessively increase, and image streaks due to passing through of the toner are unlikely to be caused. The number of carbon atoms of R^{Z2} in the formula (1) can be 18 to 22, and R^{Z2} in the formula (1) can be a linear alkyl group.

The content rate of the unit A1 can be 20.0 mass % or more with respect to the mass of the resin A. When the content rate is 20.0 mass % or more, the softening point of the toner can be easily controlled, and a tone having excellent low-temperature fixability is likely to be obtained. Accordingly, the rate is preferably 20.0 mass % or more, more preferably 30.0 mass % or more, and more preferably 50.0 mass % or more. The upper limit is not particularly limited and may be 100 mass % or less, 90.0 mass % or less, or 80.0 mass % or less.

The unit A1 can be a unit of at least one monomer selected from the group consisting of (meth)acrylic acid esters having an alkyl group having 18 to 36 carbon atoms.

Examples of the (meth)acrylic acid ester having an alkyl group having 18 to 36 carbon atoms include (meth)acrylic acid esters having a linear alkyl group having 18 to 36 carbon atoms [e.g., stearyl (meth)acrylate, nonadecyl (meth)acrylate, eicosyl (meth)acrylate, heneicosanyl (meth)acrylate, behenyl (meth)acrylate, lignoceryl (meth)acrylate, ceryl (meth)acrylate, octacocyl (meth)acrylate, myricyl (meth)acrylate, and dotriacontyl (meth)acrylate] and (meth)acrylic acid esters having branched alkyl group having 18 to 36 carbon atoms [e.g., 2-decyltetradecyl (meth)acrylate].

Among these (meth)acrylic acid esters, from the viewpoint of low-temperature fixability, at least one selected from the group consisting of (meth)acrylic acid esters having a linear alkyl group having 18 to 36 carbon atoms may be used. Furthermore, linear stearyl (meth)acrylate and/or linear behenyl (meth)acrylate may be used.

The resin A may be a crystalline resin. In the present disclosure, the term “crystalline resin” refers to a resin that exhibits a clear endothermic peak in measurement with a differential scanning calorimeter (DSC).

The resin A may be a vinyl resin, from the viewpoint of ease of control of the low-temperature fixability and other characteristics or may be a hybrid resin in which a vinyl resin and a resin other than vinyl resins bind to each other. When the resin A is a vinyl resin, the resin may be a random copolymer or block copolymer of a polymerizable monomer forming each unit.

The content rate of the resin A with respect to the mass of the toner particles is preferably 40.0 mass % or more, more preferably 50.0 mass % or more, and further preferably 60.0 mass % or more. The upper limit is not particularly limited and may be 100 mass % or less. Considering the contents of a coloring agent and a release agent contained in the toner particles, the content rate may be 90.0 mass % or less or 80.0 mass % or less.

### Unit A2

The resin A may contain a unit A2 other than the above-described unit A1. Examples of the polymerizable monomer forming the unit A2 include the followings:

monomers having a nitril group, such as acrylonitrile and methacrylonitrile;

monomers having a hydroxy group, such as 2-hydroxyethyl (meth)acrylate and 2-hydroxypropyl (meth)acrylate;

monomers having an amide group, such as acrylamide and a monomer obtained by reacting an amine having 1 to 30 carbon atoms and a carboxylic acid having 2 to 30 carbon atoms and having an ethylenically unsaturated bond (e.g., acrylic acid and methacrylic acid) by a known method;

monomers having a urea group, such as a monomer obtained by reacting an amine having 3 to 22 carbon atoms [for example, primary amine (e.g., n-butylamine, t-butylamine, propylamine, and isopropylamine), secondary amine (e.g., dinormal ethylamine, dinormal propylamine, and dinormal butylamine), aniline, and cycloxylamine] and isocyanate having 2 to 30 carbon atoms and having an ethylenically unsaturated bond by a known method;

monomers having a carboxy group, such as methacrylic acid, acrylic acid, and 2-carboxyethyl (meth)acrylate;

vinyl esters, such as vinyl acetate, vinyl propionate, vinyl butylate, vinyl caproate, vinyl caprylate, vinyl caprate, vinyl laurate, vinyl myristate, vinyl palmitate, vinyl stearate, vinyl pivalate, and vinyl octylate;

styrene and its derivative, such as styrene and o-methyl styrene; (meth)acrylic acid esters, such as methyl (meth)acrylate, n-butyl (meth)acrylate, t-butyl (meth)acrylate, and 2-ethylhexyl (meth)acrylate;

unsaturated monoolefins, such as ethylene, propylene, butylene, and isobutylene;

unsaturated polyenes, such as butadiene and isoprene; and

aromatic divinyl compounds, diacrylate compounds bound with an alkyl chain, diacrylate compounds bound with an alkyl chain including an ether bond, diacrylate compounds bound with a chain including an aromatic group and an ether bond, polyester-type diacrylates, and polyfunctional crosslinking agents.

Examples of the aromatic divinyl compound include divinyl benzene and divinyl naphthalene.

Examples of the diacrylate compounds bound with an alkyl chain include ethylene glycol diacrylate, 1,3-butylene glycol diacrylate, 1,4-butanediol diacrylate, 1,5-pentanediol diacrylate, 1,6-hexanediol diacrylate, neopentyl glycol diacrylate, and those obtained by replacing the acrylate of the above compounds with methacrylate.

As the unit A2 and the polymerizable monomer forming the unit A2, a unit A2 or a polymerizable monomer may be used alone, or a combination of two or more types of unit A2 or of two or more polymerizable monomers may be used.

### Manufacturing Example of Resin A

When the resin A is a vinyl resin, the resin A can be manufactured using a corresponding polymerizable monomer and a polymerization initiator. The polymerization initiator can be used in an amount of 0.05 parts by mass or more and 10 parts by mass or less with respect to 100 parts by mass of the polymerizable monomer from the viewpoint of efficiency.

Examples of the polymerization initiator include the followings: 2,2′-azobisisobutyronitrile, 2,2′-azobis(4-methoxy-2,4-dimethylvaleronitrile), 2,2′-azobis(2,4-dimethylvaleronitrile), 2,2′-azobis(2-methylbutyronitrile), dimethyl-2,2′-azobisisobutylate, 1,1′-azobis(1-cyclohexanecarbonitrile), 2-carbamoylazoisobutyronitrile, 2,2′-azobis(2,4,4-trimethylpentane), 2-phenylazo-2,4-dimethyl-4-methoxyvaleronitrile, 2,2′-azobis(2-methylpropane), a ketone peroxide, such as methyl ethyl ketone peroxide, acetylacetone peroxide, and cyclohexanone peroxide, 2,2-bis(tert-butylperoxy)butane, tert-butyl hydroperoxide, cumene hydroperoxide, 1,1,3,3-tetramethylbutyl hydroperoxide, di-tert-butylperoxide, tert-butylcumyl peroxide, dicumyl peroxide, α,α′-bis(tert-butylperoxyisopropyl)benzene, isobutyl peroxide, octanoyl peroxide, decanoyl peroxide, lauroyl peroxide, 3,5,5-trimethylhexanoyl peroxide, benzoyl peroxide, m-toluoyl peroxide, diisopropyl peroxydicarbonate, di-2-ethylhexyl peroxydicarbonate, di-n-propyl peroxydicarbonate, di-2-ethoxyethyl peroxycarbonate, dimethoxyisopropyl peroxydicarbonate, di(3-methyl-3-methoxybutyl) peroxycarbonate, acetylcyclohexylsulfonyl peroxide, tert-butyl peroxyacetate, tert-butyl peroxyisobutyrate, tert-butyl peroxyneodecanoate, tert-butyl peroxy-2-ethylhexanoate, tert-butyl peroxylaurate, tert-butyl peroxybenzoate, tert-butyl peroxyisopropyl carbonate, di-tert-butyl peroxyisophthalate, tert-butyl peroxyallylcarbonate, tert-amyl peroxy-2-ethylhexanoate, di-tert-butyl peroxyhexahydroterephthalate, and di-tert-butyl peroxyazelate.

When the resin A is a hybrid resin with a resin other than vinyl resins, examples of the resin other than vinyl resins include the followings:

a silicone resin, a polyester resin, polyurethane, a polyamide resin, a furan resin, an epoxy resin, a xylene resin, polyvinyl butyral, a terpene resin, a coumarone-indene resin, and a petroleum resin.

Among these resins, from the viewpoint of low-temperature fixability and chargeability control, a polyester resin may be used. The polyester resin may be either amorphous polyester or crystalline polyester, and amorphous polyester may be used.

Examples of the component constituting the polyester resin include divalent or higher alcohol monomer components and acid monomer components, such as a divalent or higher carboxylic acid, a divalent or higher carboxylic anhydride, and a divalent or higher carboxylate.

Examples of the divalent or higher alcohol monomer component include alkylene oxide adducts of bisphenol A, such as polyoxypropylene(2.2)-2,2-bis(4-hydroxyphenyl)propane, polyoxypropylene(3.3)-2,2-bis(4-hydroxyphenyl)propane, polyoxyethylene(2.0)-2,2-bis(4-hydroxyphenyl)propane, polyoxypropylene(2.0)-polyoxyethylene(2.0)-2,2-bis(4-hydroxyphenyl)propane, and polyoxypropylene(6)-2,2-bis(4-hydroxyphenyl)propane; ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-butanediene glycol, trimethylene glycol, tetramethylene glycol, pentamethylene glycol, hexamethylene glycol, octamethylene glycol, nonamethylene glycol, decamethylene glycol, neopentyl glycol, 1,4-cyclohexane dimethanol, dipropylene glycol, polyethylene glycol, polypropylene glycol, polytetramethylene glycol, sorbitol, 1,2,3,6-hexanetetrol, 1,4-sorbitan, pentaerythritol, dipentaerythritol, tripentaerythritol, 1,2,4-butanetriol, 1,2,5-pentatriol, glycerin, 2-methylpropanetriol, 2-methyl-1,2,4-butanetriol, trimethylolethane, trimethylolpropane, and 1,3,5-trihydroxymethylbenzene.

Among these alcohol monomer components, an aromatic diol may be used, and in the alcohol monomer components constituting the polyester resin, the content of the aromatic diol may be 80 mol % or more.

Examples of the acid monomer component, such as a divalent or higher carboxylic acid, a divalent or higher carboxylic anhydride, and a divalent or higher carboxylate, include aromatic dicarboxylic acids, such as phthalic acid, isophthalic acid, and terephthalic acid, and anhydrides thereof; alkyl dicarboxylic acids, such as oxalic acid, malonic acid, succinic acid, glutaric acid, adipic acid, pimelic acid, speric acid, glutaconic acid, azelaic acid, sebacic acid, nonandicarboxylic acid, decanedicarboxylic acid, undecanedicarboxylic acid, dodecanedicarboxylic acid, maleic acid, fumaric acid, mesaconic acid, citraconic acid, and itaconic acid, and anhydrides thereof; succinic acid substituted with an alkyl group or alkenyl group having 6 to 18 carbon atoms or anhydrides thereof; and unsaturated dicarboxylic acids, such as fumaric acid, maleic acid, and citraconic acid, and anhydrides thereof.

Among these acid monomer components, a polycarboxylic acid, such as terephthalic acid, succinic acid, adipic acid, fumaric acid, trimellitic acid, pyromellitic acid, and benzophenone tetracarboxylic acid, and anhydrides thereof may be used.

The toner particles according to the present disclosure may contain a resin other than the resin A. Examples of the resin other than the resin A include the followings: polyvinyl chloride, a phenol resin, a natural resin-modified phenol resin, a natural resin-modified maleic acid resin, polyvinyl acetate, a silicone resin, a polyester resin, a polyurethane resin, a polyamide resin, a furan resin, an epoxy resin, a xylene resin, polyvinyl butyral, a terpene resin, a coumarone-indene resin, and a petroleum resin.

The content of the resin other than the resin A in the toner particles may be 30.0 mass % or less or 20.0 mass % or less. The lower limit is not particularly limited and is 0.0 mass % or more.

### Toner Physical Properties

From the viewpoint of low-temperature fixability and storage stability, the softening point of the toner is preferably 70° C. or more and 120° C. or less and is more preferably 75° C. or more, more preferably 110° C. or less, and further preferably 100° C. or less.

The weight-average particle diameter (D4) of the toner is preferably 3.0 to 10.0 μm and more preferably 4.0 to 8.0 μm.

The average circularity of the toner is preferably 0.940 or more and 0.990 or less and more preferably 0.955 or more and 0.980 or less.

### Wax

The toner may contain a wax as a release agent. Examples of the wax include the followings:

hydrocarbon waxes, such as low molecular weight polyethylene, low molecular weight polypropylene, an alkylene copolymer, microcrystalline wax, paraffin wax, and Fischer-Tropsch wax; oxides of hydrocarbon waxes, such as polyethylene oxide wax, and block copolymers thereof; waxes of which the main component is fatty acid ester, such as carnauba wax; partially or wholly deoxidized fatty acid esters, such as deoxidized carnauba wax; saturated linear fatty acids, such as palmitic acid, stearic acid, and montanic acid; unsaturated fatty acids, such as brassidic acid, eleostearic acid, and parinaric acid; saturated alcohols, such as stearyl alcohol, aralkyl alcohol, behenyl alcohol, carnaubil alcohol, ceryl alcohol, and melisyl alcohol; polyhydric alcohols, such as sorbitol; esters of a fatty acid (such as palmitic acid, stearic acid, behenic acid, and montanic acid) and an alcohol (such as stearyl alcohol, aralkyl alcohol, behenyl alcohol, carnaubil alcohol, ceryl alcohol, and melisyl alcohol); fatty acid amides, such as linoleic acid amide, oleic acid amide, and lauric acid amide; saturated fatty acid bisamides, such as methylene bisstearic acid amide, ethylene biscapric acid amide, ethylene bislauric acid amide, and hexamethylene bisstearic acid amide; unsaturated fatty acid amides, such as ethylene bisoleic acid amide, hexamethylene bisoleic acid amide, N,N′-dioleyl adipic acid amide, and N,N′-dioleyl sebacic acid amide; aromatic bisamides, such as m-xylene bisstearic acid amide and N,N′-distearyl isophthalic acid amide; aliphatic metal salts (generally called as metal soap), such as calcium stearate, calcium laurate, zinc laurate, and magnesium stearate; waxes prepared by grafting an aliphatic hydrocarbon wax with a vinyl monomer, such as styrene and acrylic acid; partial ester compounds of polyhydric alcohols with fatty acid, such as behenic acid monoglyceride; and methyl ester compounds having a hydroxy group obtained by hydrogenation of vegetable oil.

Among these waxes, from the viewpoint of improving the low-temperature fixability and fixation separability, a hydrocarbon wax, such as paraffin wax and Fischer-Tropsch wax, or a fatty acid ester wax, such as carnauba wax, may be used. In terms of more improving the anti-hot offset properties, a hydrocarbon wax may be used.

The content of the wax may be 3 to 20 parts by mass with respect to 100 parts by mass of the resin contained in the toner particles.

### Coloring Agent

The toner may contain a coloring agent as needed. Examples of the coloring agent include the followings.

Examples of a black coloring agent include carbon black; and black toned with a yellow coloring agent, a magenta coloring agent, and a cyan coloring agent. As the coloring agent, a pigment may be used alone, or a combination of a dye and a pigment may be used. From the viewpoint of image quality of full color images, a dye and a pigment may be used in combination. Examples of the pigment for a magenta toner include C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48:2, 48:3, 48:4, 49, 50, 51, 52, 53, 54, 55, 57:1, 58, 60, 63, 64, 68, 81:1, 83, 87, 88, 89, 90, 112, 114, 122, 123, 146, 147, 150, 163, 184, 202, 206, 207, 209, 238, 269, and 282; C.I. Pigment Violet 19; and C.I. Pigment Violet 1, 2, 10, 13, 15, 23, 29, and 35.

Examples of the dye for a magenta toner include oil-soluble dyes, such as C.I. Solvent Red 1, 3, 8, 23, 24, 25, 27, 30, 49, 81, 82, 83, 84, 100, 109, and 121; C.I. Disperse Red 9; C.I. Solvent Violet 8, 13, 14, 21, and 27; and C.I. Disperse Violet 1, and basic dyes, such as C.I. Basic Red 1, 2, 9, 12, 13, 14, 15, 17, 18, 22, 23, 24, 27, 29, 32, 34, 35, 36, 37, 38, 39, and 40; and C.I. Basic Violet 1, 3, 7, 10, 14, 15, 21, 25, 26, 27, and 28.

Examples of the pigment for a cyan toner include C.I. Pigment Blue 2, 3, 15:2, 15:3, 15:4, 16, and 17; C.I. Vat Blue 6; C.I. Acid Blue 45, and a copper phthalocyanine pigment of which the phthalocyanine skeleton has been substituted with one to five phthalimide methyl groups.

Examples of the dye for a cyan toner include C.I. Solvent Blue 70.

Examples of the pigment for a yellow toner include C.I. Pigment Yellow 1, 2, 3, 4, 5, 6, 7, 10, 11, 12, 13, 14, 15, 16, 17, 23, 62, 65, 73, 74, 83, 93, 94, 95, 97, 109, 110, 111, 120, 127, 128, 129, 147, 151, 154, 155, 168, 174, 175, 176, 180, 181, and 185; and C.I. Vat Yellow 1, 3, and 20.

Examples of the dye for a yellow toner include C.I. Solvent Yellow 162.

These coloring agents can be used alone or as a mixture and also can be used in a solid solution state.

The coloring agent is selected in terms of hue angle, color saturation, lightness value, light fastness, OHP transparency, and dispersibility in the toner.

Content of the coloring agent may be 0.1 to 30.0 parts by mass based on the total amount of the resin component.

### Charge Control Agent

The toner may contain a charge control agent as needed. It is possible to stabilize the charge characteristics and optimize the triboelectric charge amount according to the developing system by containing a charge control agent. A known charge control agent can be used. In particular, a metal compound of an aromatic carboxylic acid, which is colorless, has a high toner charging speed, and can stably maintain a constant charge amount, may be used.

Examples of the negative charge control agent include the followings:

a salicylic acid metal compound, a naphthoic acid metal compound, a dicarboxylic acid metal compound, a polymer compound having sulfonic acid or carboxylic acid in a side chain, a polymer compound having a sulfonate or esterified sulfonic acid in a side chain, a polymer compound having a carboxylate or esterified carboxylic acid in a side chain, a boron compound, a urea compound, a silicon compound, and a calixarene.

The charge control agent may be internally added or externally added to the toner particles. The content of the charge control agent is preferably 0.2 to 10.0 parts by mass and more preferably 0.5 to 10.0 parts by mass with respect to 100 parts by mass of the resin contained in the toner.

### Inorganic Microparticles

The toner may contain inorganic microparticles as needed. The inorganic microparticles may be internally added to the toner particles or may be mixed with the toner particles as an external additive.

Examples of the inorganic microparticles include microparticles, such as silica microparticles, titanium oxide microparticles, alumina microparticles, and their complex oxide microparticles. Among the inorganic microparticles, silica microparticles or titanium oxide microparticles may be used for improving the flowability and uniformizing the charge.

The inorganic microparticles may be hydrophobized with a hydrophobizing agent such as a silane compound, a silicone oil, or a mixture thereof.

From the viewpoint of improving flowability and durable stability, the inorganic microparticles as an external additive may have a specific surface area of 50 to 400 m²/g.

The content of the external additive may be 0.1 to 10.0 parts by mass with respect to 100 parts by mass of the toner particles. The toner particles and the external additive can be mixed with a known mixer such as a Henschel mixer.

### Developer

The toner can also be used as a one-component developer, but in order to further improve the dot reproducibility and to supply stable images for a long period of time, the toner may be mixed with a magnetic carrier and used as a two-component developer.

Examples of the magnetic carrier include the followings:

iron oxide; metal particles, such as iron, lithium, calcium, magnesium, nickel, copper, zinc, cobalt, manganese, chromium, and rare earth elements, particles of alloys thereof, and particles of oxides thereof; magnetic materials such as ferrite; and a magnetic material-dispersed resin carrier (so-called resin carrier) containing a magnetic material and a binder resin that holds the magnetic material in a dispersed state.

When the toner is mixed with a magnetic carrier and is used as a two-component developer, the mixing rate of the magnetic carrier is preferably 2 to 15 mass % and more preferably 4 to 13 mass % as the toner concentration in the two-component developer.

### Method for Manufacturing Toner

The method for manufacturing the toner of the present disclosure is not particularly limited, and a known method, such as a pulverization method, a suspension polymerization method, a dissolution suspension method, an emulsion aggregation method, and a dispersion polymerization method, can be used.

### Electrophotographic Photoreceptor

### Fluorine-Based Polymer B

The electrophotographic photoreceptor of the present disclosure includes a surface layer containing (i) fluorine-containing resin particles and (ii) a fluorine-based polymer B including a unit B1 represented by the following formula (2) and a unit B2 represented by the following formula (3):

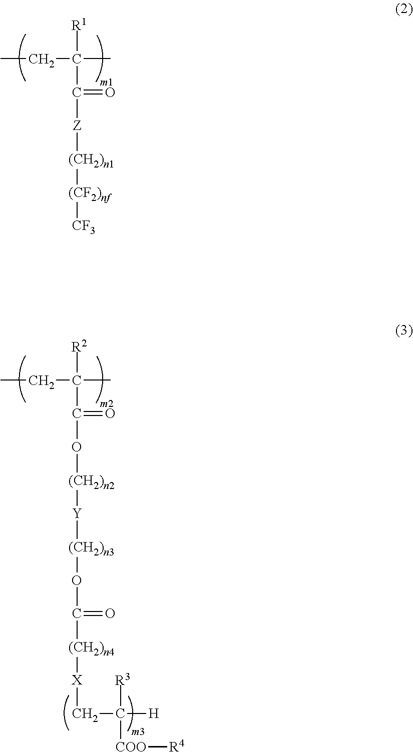

(in the formulae (2) and (3), R¹, R², R³, and R⁴ each independently represent a hydrogen atom or an alkyl group; X represents an alkylene group, a halogen-substituted alkylene group, —S—, —O—, —NH—, or a single bond; Y represents an alkylene group, a halogen-substituted alkylene group, an alkylene group including a hydroxy group, or a single bond; Z represents —O— or —NH—; m1, m2, and m3 each independently represent an integer of 1 or more; n1, n2, n3, and n4 each independently represent an integer of 0 or more; and nf represents an integer of 1 to 5).

In the above, n1, n2, n3, and n4 may be each 1 to 3; R¹, R², R³, and R⁴ may be each a hydrogen atom or an alkyl group; X may be —S— or —O—; Y may be a methylene group, a halogen-substituted methylene group, or a hydroxy-substituted methylene group and may be a hydroxy-substituted methylene group; Z may be —O—; m3 may be 50 to 70; and nf may be 2 or 3.

It is inferred that when the unit B1 is contained in the fluorine-based polymer B, the affinity to the fluorine-containing resin particles is likely to increase, and the fluorine-containing resin particles can be less likely to aggregate. It is also inferred that when the unit B2 is contained in the fluorine-based polymer B, the affinity to the solvent and another resin material during formation of the surface layer is likely to increase, and the fluorine-based polymer B is likely to be dispersed in the surface layer.

The content rate of the unit B1 may be 40.0 to 60.0 mass % based on the mass of the fluorine-based polymer B. The content rate of the unit B2 may be 40.0 to 60.0 mass % based on the mass of the fluorine-based polymer B.

In the fluorine-based polymer B, the form of the copolymer of the unit B1 and the unit B2 is not particularly limited.

The weight-average molecular weight of the fluorine-based polymer B according to the present disclosure is preferably 60,000 or more and 129,000 or less, and is more preferably 90,000 or more, and is more preferably 110,000 or less.

### Fluorine-Containing Resin Particles

From the viewpoint of making image streaks less likely to occur, the fluorine-containing resin particles according to the present disclosure may be polytetrafluoroethylene particles. The primary particles of the polytetrafluoroethylene particles contained in the surface layer preferably has a number-average particle diameter of the 150 nm or more and 195 nm or less and more preferably 170 nm or more and 195 nm or less.

The content of the fluorine-containing resin particles may be 20.0 mass % or more and 40.0 mass % or less based on the mass of the surface layer.

In addition, among the polytetrafluoroethylene particles contained in the surface layer, the presence rate of the polytetrafluoroethylene particles having a primary particle diameter of 150 nm or less may be 10% or more, and the presence rate of the polytetrafluoroethylene particles having a primary particle diameter of 250 nm or more may be 5% or less.

The number-average molecular weight of the polytetrafluoroethylene particles is preferably 12,000 or more and 20,000 or less, and is more preferably 14,000, and is more preferably 18,000 or less. The methods for measuring the primary particle diameter and number-average molecular weight of the polytetrafluoroethylene particles will be described later.

The fluorine-based polymer including the unit B1 and the unit B2 according to the present disclosure can be synthesized, for example, according to the procedure described in Japanese Patent Laid-Open No. 2009-104145.

### Surface Layer

The surface layer according to the present disclosure is the outermost layer of the electrophotographic photoreceptor. In the electrophotographic photoreceptor of the present disclosure, a photosensitive layer is formed on a conductive support and may be used as the surface layer. In this case, when the photosensitive layer is of a single-layer type, the photosensitive layer itself is the surface layer. When the photosensitive layer is of a multi-layer type and when the outermost surface of the photosensitive layer is used as a charge transport layer, the charge transport layer is the surface layer according to the present disclosure. Alternatively, a protective layer is formed on the photosensitive layer formed on the conductive support, and the protective layer may be used as the surface layer. In the electrophotographic photoreceptor of the present disclosure, a conductive layer, an undercoat layer, or both may be disposed between a conductive support and a charge generation layer.

As the method for manufacturing the electrophotographic photoreceptor of the present disclosure, a method by preparing coating solutions of layers described later, applying the solutions in a desired order of the layers, and drying them is mentioned. In this method, examples of the method for applying the coating solutions include dipping coating, spray coating, ink jet coating, roll coating, die coating, blade coating, curtain coating, wire bar coating, and ring coating. Among these methods, from the viewpoint of efficiency and productivity, dipping coating may be used.

Each of the components of the electrophotographic photoreceptor, such as the conductive support, the conductive layer, the undercoat layer, the photosensitive layer, and the protective layer, will be described.

### Conductive Support

In the present disclosure, the electrophotographic photoreceptor includes a conductive support. The shape of the conductive support is, for example, cylindrical, belt-like, or sheet-like. In particular, the shape may be cylindrical. The surface of the conductive support may be subjected to electrochemical treatment such as anodization, or blast treatment, or cutting treatment.

The material of the conductive support may be a metal, a resin, or glass. Examples of the metal include aluminum, iron, nickel, copper, gold, stainless steel, and alloys thereof. In particular, the conductive support may be an aluminum support. A resin or glass may be provided with conductivity by treatment such as mixing or coating with a conductive material.

### Conductive Layer

In the present disclosure, a conductive layer may be disposed on the conductive support. Scratches and unevenness on the surface of the conductive support can be covered by providing the conductive layer, and reflection of light on the conductive support surface can also be suppressed.

The conductive layer may contain conductive particles and a resin.

Examples of the material of the conductive particles include a metal oxide, a metal, and carbon black.

Examples of the metal oxide include zinc oxide, aluminum oxide, indium oxide, silicon oxide, zirconium oxide, tin oxide, titanium oxide, strontium oxide, magnesium oxide, antimony oxide, bismuth oxide, and strontium titanate. Examples of the metal include aluminum, nickel, iron, chromium, copper, zinc, and silver.

Among these materials, a metal oxide may be used as the conductive particles, in particular, titanium oxide, tin oxide, or zinc oxide may be used.

When a metal oxide is used as the conductive particles, the surface of the metal oxide may be treated with, for example, a silane coupling agent, or the metal oxide may be doped with an element, such as phosphorus or aluminum, or an oxide thereof.

The conductive particles may have a laminate configuration including a core particle and a cover layer covering the particle. Examples of the core particle include titanium oxide, barium oxide, and zinc oxide.

Examples of the cover layer include a metal oxide such as tin oxide.

When a metal oxide is used as the conductive particles, the volume-average particle diameter is preferably 1 nm or more and 500 nm or less and more preferably 3 nm or more and 400 nm or less.

Examples of the resin contained in the conductive layer include a polyester resin, a polycarbonate resin, a polyvinyl acetal resin, an acrylic resin, a silicone resin, an epoxy resin, a melamine resin, a polyurethane resin, a phenol resin, and alkyd resin.

The conductive layer may further contain a covering agent such as silicone oil, resin particles, and titanium oxide.

The average thickness of the conductive layer is preferably 1 μm or more and 50 μm or less and particularly preferably 3 μm or more and 40 μm or less.

The conductive layer can be formed by preparing a coating solution for a conductive layer containing the above-described materials and a solvent, forming a coating film of this solution, and drying it. Examples of the solvent used for the coating solution include an alcohol solvent, a sulfoxide solvent, a ketone solvent, an ether solvent, an ester solvent, and an aromatic hydrocarbon solvent. Examples of the dispersing method for dispersing the conductive particles in the coating solution for a conductive layer include methods using a paint shaker, a sand mill, a ball mill, or a liquid collision type high speed disperser.

### Undercoat Layer

In the present disclosure, an undercoat layer may be disposed on the conductive support or the conductive layer. The adhesive function between layers is enhanced by disposing the undercoat layer, and the charge injection preventing function can be imparted.

The undercoat layer may contain a resin. The undercoat layer may be formed as a cured film by polymerizing a composition containing a monomer having a polymerizable functional group.

Examples of the resin contained in the undercoat layer include a polyester resin, a polycarbonate resin, a polyvinyl acetal resin, an acrylic resin, an epoxy resin, a melamine resin, a polyurethane resin, a phenol resin, a polyvinyl phenol resin, an alkyd resin, a polyvinyl alcohol resin, a polyethylene oxide resin, a polypropylene oxide resin, a polyamide resin, a polyamide acid resin, a polyimide resin, a polyamideimide resin, and a cellulose resin.

Examples of the polymerizable functional group of the monomer having a polymerizable functional group include an isocyanate group, a block isocyanate group, a methylol group, an alkylated methylol group, an epoxy group, a metal alkoxide group, a hydroxy group, an amino group, a carboxy group, a thiol group, a carboxylic anhydride group, and a carbon-carbon double bond group.

In addition, the undercoat layer may further contain, for example, an electron transport material, a metal oxide, a metal, and a conductive polymer for the purpose of enhancing the electrical characteristics. Among these materials, an electron transport material and a metal oxide may be used.

Examples of the electron transport material include a quinone compound, an imide compound, a benzimidazole compound, a cyclopentadienylidene compound, a fluorenone compound, a xanthone compound, a benzophenone compound, a cyanovinyl compound, a halogenated aryl compound, a silole compound, and a boron-containing compound. The undercoat layer may be formed as a cured film by using an electron transport material having a polymerizable functional group as the electron transport material and copolymerizing with the above-mentioned monomer having a polymerizable functional group.

Examples of the metal oxide include indium tin oxide, tin oxide, indium oxide, titanium oxide, strontium oxide, zinc oxide, aluminum oxide, strontium titanate, and silicon dioxide. Examples of the metal include gold, silver, and aluminum.

The undercoat layer may contain an additive.

The average thickness of the undercoat layer is preferably 0.1 μm or more and 50 μm or less, more preferably 0.2 μM or more and 40 μm or less, and particularly preferably 0.3 μm or more and 30 μm or less.

The undercoat layer can be formed by preparing a coating solution for an undercoat layer containing the above-described materials and a solvent, forming a coating film of this solution, and drying and/or curing it. Examples of the solvent used for the coating solution include an alcohol solvent, a ketone solvent, an ether solvent, an ester solvent, and an aromatic hydrocarbon solvent.

### Photosensitive Layer

The photosensitive layer of the electrophotographic photoreceptor is mainly classified into (1) a multi-layer type photosensitive layer and (2) a single-layer type photosensitive layer. (1) The multi-layer type photosensitive layer includes a charge generation layer containing a charge generation material and a charge transport layer containing a charge transport material. (2) The single-layer type photosensitive layer includes a photosensitive layer containing both a charge generation material and a charge transport material.

### (1) Multi-Layer Type Photosensitive Layer

The multi-layer type photosensitive layer includes a charge generation layer and a charge transport layer.

### (1-1) Charge Generation Layer

The charge generation layer may contain a charge generation material and a resin.

Examples of the charge generation material include an azo pigment, a perylene pigment, a polycyclic quinone pigment, an indigo pigment, and a phthalocyanine pigment. Among these materials, an azo pigment or a phthalocyanine pigment may be used. The phthalocyanine pigment may be an oxytitanium phthalocyanine pigment, a chlorogallium phthalocyanine pigment, or a hydroxygallium phthalocyanine pigment.

The content of the charge generation material in the charge generation layer is preferably 40 mass % or more and 85 mass % or less and more preferably 60 mass % or more and 80 mass % or less based on the total mass of the charge generation layer.

Examples of the resin contained in the charge generation layer include a polyester resin, a polycarbonate resin, a polyvinyl acetal resin, a polyvinyl butyral resin, an acrylic resin, a silicone resin, an epoxy resin, a melamine resin, a polyurethane resin, a phenol resin, a polyvinyl alcohol resin, a cellulose resin, a polystyrene resin, a polyvinyl acetate resin, and a polyvinyl chloride resin. Among these resins, a polyvinyl butyral resin may be used.

The charge generation layer may further contain additives such as an antioxidant and an ultraviolet absorber.

Specifically, examples of the additive include a hindered phenol compound, a hindered amine compound, a sulfur compound, a phosphorus compound, and a benzophenone compound.

The average thickness of the charge generation layer is preferably 0.1 μm or more and 1 μm or less and more preferably 0.15 μm or more and 0.4 μm or less.

The charge generation layer can be formed by preparing a coating solution for a charge generation layer containing the above-described materials and a solvent, forming a coating film of this solution, and drying it. Examples of the solvent used for the coating solution include an alcohol solvent, a sulfoxide solvent, a ketone solvent, an ether solvent, an ester solvent, and an aromatic hydrocarbon solvent.

### (1-2) Charge Transport Layer

The charge transport layer contains a charge transport material and a resin.

Examples of the charge transport material include a polycyclic aromatic compound, a heterocyclic compound, a hydrazone compound, a styryl compound, an enamine compound, a benzidine compound, a triarylamine compound, and a resin having a group derived from these materials. Among these materials, a triarylamine compound or a benzidine compound may be used. These materials may be used alone or as a mixture of two or more.

The content of the charge transport material in the charge transport layer is preferably 25 mass % or more and 70 mass % or less and more preferably 30 mass % or more and 55 mass % or less based on the total mass of the charge transport layer.

Examples of the resin contained in the charge transport layer include a polyester resin, a polycarbonate resin, an acrylic resin, and a polystyrene resin. Among these resins, a polycarbonate resin or a polyester resin may be used.

When the charge transport layer is the outermost surface of the electrophotographic photoreceptor and the charge transport layer is the surface layer, the charge transport layer contains the above-described fluorine-containing resin particles and fluorine-based polymer B.

The charge transport layer may further contain additives, such as an antioxidant, an ultraviolet absorber, a plasticizer, a leveling agent, and an abrasion resistance improving agent. Specifically, examples of the additive include a hindered phenol compound, a hindered amine compound, a sulfur compound, a phosphorus compound, a benzophenone compound, a siloxane modified resin, silicone oil, a fluorine resin particle, a polystyrene resin particle, a polyethylene resin particle, a silica particle, an alumina particle, and a boron nitride particle.

The average thickness of the charge transport layer may be 5 μm or more and 50 μm or less. When the charge transport layer is used as the surface layer, the average thickness may be 30 μm or more and 45 μm or less.

When a protective layer is disposed on the charge transport layer, the average thickness is preferably 8 μm or more and 40 μm or less and particularly preferably 10 μm or more and 30 μm or less.

The charge transport layer can be formed by preparing a coating solution for a charge transport layer containing the above-described materials and a solvent, forming a coating film of this solution, and drying it. Examples of the solvent used for the coating solution include an alcohol solvent, a ketone solvent, an ether solvent, an ester solvent, and an aromatic hydrocarbon solvent. Among these solvents, an ether solvent or an aromatic hydrocarbon solvent may be used.

### (2) Single-Layer Type Photosensitive Layer

The single-layer type photosensitive layer can be formed by preparing a coating solution for a photosensitive layer containing a charge generation material, a charge transport material, a resin, and a solvent, forming a coating film of this solution, and drying it. The charge generation material, the charge transport material, and the resin are the same as the materials in the “(1) Multi-layer type photosensitive layer” above.

### Protective Layer

In the present disclosure, a protective layer may be disposed on the photosensitive layer. The photosensitive layer can be protected from scraping by disposing the protective layer, and the endurance of the electrophotographic photoreceptor can be improved. When the protective layer is the outermost surface of the electrophotographic photoreceptor and is used as the surface layer, the protective layer contains the above-described fluorine-containing resin particles and fluorine-based polymer B.

The protective layer may contain a charge transport material in addition to the above-described fluorine-containing resin particles and fluorine-based polymer B. Examples of the charge transport material include a polycyclic aromatic compound, a heterocyclic compound, a hydrazone compound, a styryl compound, an enamine compound, a benzidine compound, a triarylamine compound, and a resin having a group derived from these materials. Among these materials, a triarylamine compound or a benzidine compound may be used.

The protective layer may contain another resin in addition to the above-described fluorine-containing resin particles and fluorine-based polymer B. Examples of the additional resin contained in the protective layer include a polyester resin, an acrylic resin, a phenoxy resin, a polycarbonate resin, a polystyrene resin, a phenol resin, a melamine resin, and an epoxy resin.

The protective layer may be formed as a cured film by curing and polymerizing a composition containing a monomer having a polymerizable functional group. Examples of the reaction for the formation include a thermal polymerization reaction, a photopolymerization reaction, and a radiation polymerization reaction. Examples of the polymerizable functional group of the monomer having a polymerizable functional group include a (meth)acrylic group. As the monomer having a polymerizable functional group, a material having charge transport ability may be used.

Furthermore, the protective layer may contain conductive particles in addition to the above-described fluorine-containing resin particles and fluorine-based polymer B. Examples of the conductive particles include particles of a metal oxide, such as titanium oxide, zinc oxide, tin oxide, and indium oxide. The protective layer may contain additives, such as an antioxidant, an ultraviolet absorber, a plasticizer, and a leveling agent. Specifically, examples of the additive include a hindered phenol compound, a hindered amine compound, a sulfur compound, a phosphorus compound, a benzophenone compound, a siloxane modified resin, silicone oil, a polystyrene resin particle, a polyethylene resin particle, a silica particle, an alumina particle, and a boron nitride particle.

The average thickness of the protective layer is preferably 0.5 μm or more and 10 μm or less, and is preferably 1 μm or more, and is preferably 7 μm or less.

The protective layer can be formed by preparing a coating solution for a protective layer containing the above-described materials and a solvent, forming a coating film of this solution, and drying and/or curing it. Examples of the solvent used for the coating solution include an alcohol solvent, a ketone solvent, an ether solvent, a sulfoxide solvent, an ester solvent, and an aromatic hydrocarbon solvent.

### Image Forming Method

The image forming method according to the present disclosure is an image forming method including:

a charging step of charging a surface of an electrophotographic photoreceptor;

an image exposure step of irradiating the charged surface of the electrophotographic photoreceptor with image exposure light to form an electrostatic latent image on the surface of the electrophotographic photoreceptor;

a developing step of developing the electrostatic latent image with a toner to form a toner image on the surface of the electrophotographic photoreceptor;

a transferring step of transferring the toner image from the surface of the electrophotographic photoreceptor onto a transfer material;

a cleaning step of removing the toner remaining on the surface of the electrophotographic photoreceptor with a cleaning blade after the transferring step; and

a fixing step of fixing the toner image transferred to the transfer material to the transfer material.

### Process Cartridge and Electrophotographic Apparatus

The process cartridge according to the present disclosure is a process cartridge that is attachable to and detachable from an electrophotographic apparatus main body and integrally supports at least one device selected from the group consisting of a charging device, an exposing device, a developing device, a transferring device, and a cleaning device. The process cartridge includes the toner and electrophotographic photoreceptor according to the present disclosure.

The electrophotographic apparatus according to the present disclosure is an image forming apparatus including a charging device, an exposing device, a developing device, a transferring device, a fixing device, and a cleaning device and includes the toner and electrophotographic photoreceptor according to the present disclosure.

The above-mentioned charging device is a device for charging a surface of the electrophotographic photoreceptor. The exposing device is a device for irradiating the charged surface of the electrophotographic photoreceptor with image exposure light to form an electrostatic latent image on the surface of the electrophotographic photoreceptor. The developing device is a device for developing the electrostatic latent image with a toner to form a toner image on the surface of the electrophotographic photoreceptor. The transferring device is a device for transferring the toner image from the surface of the electrophotographic photoreceptor onto a transfer material. The cleaning device is a device for removing the toner remaining on the surface of the electrophotographic photoreceptor with a cleaning blade after the transferring step.

FIGURE shows an example of a schematic structure of the electrophotographic apparatus provided with the process cartridge including the electrophotographic photoreceptor.

In FIGURE, a cylindrical electrophotographic photoreceptor 1 is rotationally driven about a shaft 2 in a direction indicated by the arrow at a predetermined peripheral speed. The surface of the electrophotographic photoreceptor 1 is charged to a predetermined positive or negative potential by a charging unit 3. Although FIGURE illustrates a roller charging system based on a roller-type charging member, another charging system, such as a corona charging system, a proximity charging system, or an injection charging system, may be adopted. The charged surface of the electrophotographic photoreceptor 1 is irradiated with exposure light 4 from an exposing device (not shown) to form an electrostatic latent image corresponding to target image information. The electrostatic latent image formed on the surface of the electrophotographic photoreceptor 1 is developed with a toner stored in a developing device 5 to form a toner image on the surface of the electrophotographic photoreceptor 1. The toner image formed on the surface of the electrophotographic photoreceptor 1 is transferred onto a transfer material 7 by a transferring device 6. The transfer material 7 onto which the toner image has been transferred is conveyed to a fixing device 8, is subjected to treatment for fixing the toner image, and is printed out to the outside of the electrophotographic apparatus. The electrophotographic apparatus may include a cleaning device 9 for removing deposit, such as the toner remaining on the surface of the electrophotographic photoreceptor 1 after the transferring. Alternatively, without separately providing a cleaning device, a so-called cleaner-less system, which removes the deposit with, for example, a developing device, may be used. The electrophotographic apparatus may include an electricity-removing mechanism (electricity-removing device) for electricity-removing treatment of the surface of the electrophotographic photoreceptor 1 with pre-exposure light 10 from a pre-exposing device (not shown). In addition, a guiding device 12, such as a rail, may be provided for attaching and detaching the process cartridge of the present disclosure to and from the electrophotographic apparatus main body.

The electrophotographic photoreceptor of the present disclosure can be used in, for example, a laser beam printer, an LED printer, a copying machine, a facsimile, and a multifunctional peripheral thereof.

### Various Measurement Methods

### Method for Measuring Weight-Average Molecular Weight

The weight-average molecular weight of a specimen is measured according to a usual method as follows.

The specimen is placed in tetrahydrofuran and is left to stand for several hours. The measuring object and tetrahydrofuran are then mixed thoroughly while shaking (until the unity of the measuring object disappears), followed by being left to stand for further 12 hours or more. Subsequently, the mixture is allowed to pass through a sample treatment filter (trade name: Myshori Disk H-25-5, manufactured by Tosoh Corporation) is used as a specimen for gel permeation chromatography (GPC).

Subsequently, a column is stabilized in a heat chamber of 40° C., tetrahydrofuran as a solvent is allowed to flow through the column at this temperature at a flow rate of 1 mL/min, and 10 μL of the specimen for GPC is injected into the column to measure the weight-average molecular weight of the measuring object. As the column, a column (trade name: TSK gel Super HM-M) manufactured by Tosoh Corporation is used.

In the measurement of the weight-average molecular weight, a GPC chart is obtained by calculating molecular weight distribution of the measuring object from a relationship between the logarithmic value of the calibration curve drawn from several types of monodisperse standard polystyrene samples and the number of counts. As the standard polystyrene samples for drawing the calibration curve, ten monodisperse polystyrenes having molecular weights of 3,500, 12,000, 40,000, 75,000, 98,000, 120,000, 240,000, 500,000, 800,000, and 1,800,000 manufactured by Sigma-Aldrich Co. LLC are used.

As the detector, an RI (refractive index) detector is used.

### Method for Measuring Primary Particle Diameter of Particle Specimen

The particle specimen is attached to commercially available carbon conductive tape, particles not adhering to the conductive tape is removed by compressed air, and platinum deposition is performed. The deposited particles are observed using FE-SEM (S-4700) manufactured by Hitachi High-Technologies Corporation. The measurement conditions of FE-SEM are set as follows:

Acceleration voltage: 2 kV,

### WD: 5 mm,

Magnification: 20,000 times, and
Number of pixels: vertical 1,280 pixels, horizontal 960 pixels (size per pixel: 5 nm).

The Feret diameters of 500 particles were determined from the resulting image using Image J (Open Source Software manufactured by National Institutes of Health (NIH)), and the average thereof is defined as the number-average particle diameter of primary particles. The presence rate of particles is calculated from the determined value.

### Method for Measuring Number-Average Molecular Weight of Polytetrafluoroethylene Particles

The number-average molecular weight of polytetrafluoroethylene particles is calculated from the measurement results of differential scanning calorimetry (hereinafter, abbreviated to DSC) by the method described in Japanese Journal of Polymer Science and Technology (Kobunshi Ronbunshu), Vol. 36, No. 6, pp. 393-399 (1979). The method will be specifically described below.

The measurement is performed using DSC822e manufactured by Mettler-Toledo as the DSC in a nitrogen atmosphere. Polytetrafluoroethylene particles are placed in a 40-μL aluminum sample pan, and the temperature is increased from 25° C. to 350° C. at a temperature increase rate of 16° C./min. Subsequently, the temperature of 350° C. is maintained for 10 minutes, and the temperature is then decreased to 280° C. at a temperature decrease rate of 16° C./min. The crystallization heat ΔHc is determined from the peak at the time of this temperature decrease.

Furthermore, the number-average molecular weight Mn is determined from the crystallization heat \Hc using the Formula (a):

Mn=2.1×10¹⁰×ΔHc^{-5.16} Formula (a).

### Measurement of Softening Point of Toner

The softening point of a toner is measured using a constant load extrusion type capillary rheometer “Flow Characteristic Evaluation Apparatus Flow Tester CFT-500D” (manufactured by Shimadzu Corporation) according to the manual attached to the apparatus. In this apparatus, a cylinder is filled with a measurement specimen, the temperature is increased while applying a constant load to the top of the measurement specimen by a piston to melt the specimen, the melted measurement specimen is extruded from the die at the bottom of the cylinder, and a flow curve showing a relationship between the amount of descent of the piston and the temperature in this procedure can be obtained.

The “melting temperature by the ½ method” described in the manual attached to the “Flow Characteristic Evaluation Apparatus Flow Tester CFT-500D” is defined as the softening point. The melting temperature by the ½ method is calculated as follows.

First, ½ of the difference between the amount of descent of the piston at the time of the end of outflow (the end point of outflow, referred to as Smax) and the amount of descent of the piston at the time of the start of outflow (the lowest point, referred to as Smin) is determined (this is referred to as X, X=(Smax−Smin)/2). The temperature of the flow curve when the amount of descent of the piston is the sum of X and Smin is the melting temperature by the ½ method.

The measurement specimen is a resin molded into a cylindrical shape having a diameter of about 8 mm by compressive molding about 1.0 g of the resin under an environment of 25° C. at about 10 MPa for about 60 seconds using a tablet molding compressor (e.g., NT-100H, manufactured by NPa SYSTEM Co., Ltd.).

Specific operation in the measurement is performed according to the manual attached to the apparatus.

The measurement conditions of CFT-500D are as follows:

Test mode: temperature-rising method,
Starting temperature: 50° C.,
Reach temperature: 200° C.,
Measurement interval: 1.0° C.,
Temperature increase rate: 4.0° C./min,
Piston cross-sectional area: 1.000 cm²,
Test load (piston load): 10.0 kgf (0.9807 MPa),
Preheating time: 300 seconds,
Diameter of the die hole: 1.0 mm, and

### Length of the die: 1.0 mm.

### Method for Measuring Weight-Average Particle Diameter (D4) of Toner

The weight-average particle diameter (D4) of a toner is calculated as follows. As the measuring apparatus, a precision particle size distribution measuring apparatus “Coulter Counter Multisizer 3” (registered trademark, manufactured by Beckman Coulter, Inc.) equipped with a 100-μm aperture tube for an aperture impedance method is used. The setting of measurement conditions and analysis of measurement data use the attached dedicated software “Beckman Coulter Multisizer 3 Version 3.51” (manufactured by Beckman Coulter, Inc.). The measurement is performed at 25,000 effective measuring channels.

As the electrolyte aqueous solution to be used in the measurement, a solution prepared by dissolving special grade sodium chloride in deionized water so as to give a concentration of about 1 mass %, for example, “ISOTON II” (manufactured by Beckman Coulter, Inc.), can be used.

Before the measurement and the analysis, the dedicated software is set as follows. On the “Change standard measurement method (SOM)” screen of the dedicated software, the total number of counts of the control mode is set to 50,000 particles, the number of measurements is set to 1, and the Kd value is set to the value obtained using “standard particles 10.0 μm” (manufactured by Beckman Coulter, Inc.). The threshold value and noise level are automatically set by pressing the “threshold/noise level measurement” button. The current is set to 1,600 μA, the gain is set to 2, the electrolyte solution is set to ISOTON II, and a check is entered for the “Flush aperture tube after measurement”.

On the “Conversion settings from pulse to particle diameter” screen of the dedicated software, the bin intervals is set to logarithmic particle diameter, the particle diameter bins are set to 256 particle diameter bins, and the particle diameter range is set to 2 to 60 μm.

The specific measurement methods are as follows:

(1) About 200 mL of an electrolyte aqueous solution is placed in a 250-mL glass round-bottom beaker dedicated for Multisizer 3, the beaker is set in the sample stand, and stirring with a stirrer rod is performed counter-clockwise at a rate of 24 rps. Contamination and bubbles in the aperture tube are removed by the “flush of aperture tube” function of the dedicated software.
(2) About 30 mL of the electrolyte aqueous solution is placed in a 100-mL glass flat-bottom beaker, and 0.3 mL of a dilution of “Contaminon N” (a 10 mass % aqueous solution of precision measuring apparatus-washing neutral detergent consisting of a nonionic surfactant, an anionic surfactant, and an organic builder and having a pH of 7, manufactured by FUJIFILM Wako Pure Chemical Corporation) diluted 3-fold by mass with deionized water is added to the beaker as a dispersing agent.
(3) An ultrasonic disperser “Ultrasonic Dispersion System Tetora 150” (manufactured by Nikkaki Bios Co., Ltd.) equipped with two built-in oscillators having an oscillating frequency of 50 kHz with their phases shifted by 180 degrees from each other and having an electric output of 120 W is prepared. 3.3 L of deionized water is placed in the water tank of the ultrasonic disperser, and about 2 mL of Contaminon N is added to the water tank.
(4) The beaker in the above (2) is set to the beaker-fixing hole of the ultrasonic disperser, and the ultrasonic disperser is operated. The height position of the beaker is then adjusted so as to maximize the resonant condition of the liquid surface of the electrolyte aqueous solution in the beaker.
(5) While exposing the electrolyte aqueous solution in the beaker of the above (4) to ultrasonics, 10 mg of the toner particles are added little by little to the electrolyte aqueous solution and are dispersed therein. The ultrasonic dispersion treatment is further continued for 60 seconds. Incidentally, during the ultrasonic dispersion, the water temperature in the water tank is appropriately adjusted to 10° C. to 40° C.
(6) The electrolyte aqueous solution of the above (5) in which the toner particles are dispersed is dropwise added with a pipette to the round-bottom beaker of the above (1) set in the sample stand, and the measurement concentration is adjusted to about 5%. Measurement is performed until the number of measured particles reaches 50,000.
(7) The measurement data are analyzed with dedicated software attached to the apparatus, and the weight-average particle diameter (D4) is calculated. The weight-average particle diameter (D4) is the “Average diameter” on the “Analysis/volume statistical value (arithmetic mean)” screen when the dedicated software is set to graph/volume %. Method for measuring average circularity of toner

The average circularity of a toner is measured with a flow type particle image analyzer “FPIA-3000” (manufactured by Sysmex Corporation) in measurement and analysis conditions during calibration working.

The measurement principle of the flow type particle image analyzer “FPIA-3000” (manufactured by Sysmex Corporation) is image analysis by taking images of flowing particles as still images. A specimen added to a sample chamber is sent to a flat sheath flow cell with a sample suction syringe. The specimen sent to the flat sheath flow is sandwiched by sheath streams to form a flat flow. The specimen passing through the inside of the flat sheath flow cell is irradiated with strobe light at 1/60 second intervals, and the flowing particles can be photographed as still images. In addition, since the flow is flat, the images are taken in focus. Particle images are taken with a CCD camera, the taken images are subjected to image processing with image processing resolution of 512×512 pixels (0.37×0.37 μm per pixel), contour extraction of each particle image is performed, and, for example, the projection image S and the circumference length L of a particle image are measured.

Subsequently, the circle-equivalent diameter and the circularity are determined using the area S and the circumference length L. The circle-equivalent diameter is the diameter of a circle that has the same area as the projection image of the particle image. The circularity C is defined as the value obtained by dividing the circumference length of a circle determined from the circle-equivalent diameter by the circumference length of a particle projection image, and is calculated by the following equation:

Circularity C=2×(π×S)^{1/2}/L.

When the particle image is a circle, the circularity is 1.000. The value of circularity decreases with an increase in the degree of unevenness of the particle image outer periphery. The circularity of each particle is calculated, a circularity range of 0.200 or more and 1.000 or less is divided into 800, and the additive average value of the resulting circularities is calculated as the average circularity.

Specifically, the measurement method is as follows.

About 20 mL of deionized water from which impurity solids and so on have been removed in advance is placed in a glass container. About 0.2 mL of a dilution of “Contaminon N” (a 10 mass % aqueous solution of precision measuring apparatus-washing neutral detergent consisting of a nonionic surfactant, an anionic surfactant, and an organic builder and having a pH of 7, manufactured by FUJIFILM Wako Pure Chemical Corporation) diluted 3-fold by mass with deionized water is added to the container as a dispersing agent.

Furthermore, about 0.02 g of a measurement specimen is added to the container, and dispersion treatment using an ultrasonic disperser is performed for 2 minutes to obtain a dispersion for measurement. During the treatment, cooling is appropriately performed such that the temperature of the dispersion is 10° C. to 40° C.

As the ultrasonic disperser, a desktop ultrasonic washer disperser (“VS-150” (manufactured by VELVO-CLEAR)) with an oscillation frequency of 50 kHz and an electric output of 150 W is used. A predetermined amount of deionized water is placed in a water tank, and about 2 mL of the Contaminon N is added to this water tank.

The measurement uses the flow type particle image analyzer equipped with a standard objective lens (10×), and Particle Sheath “PSE-900A” (manufactured by Sysmex Corporation) is used as sheath liquid.

The dispersion prepared according to the above procedure is introduced to the flow type particle image analyzer, and 3,000 toner particles are measured according to an HPF measurement mode and a total count mode.

The average circularity of the toner is determined by setting the binarization threshold at the time of particle analysis to 85% and limiting the particle diameters to be analyzed to a circle-equivalent diameter of 1.98 to 39.96 μm.

In the measurement, prior to the start of the measurement, automatic focusing is performed using standard latex particles (for example, a dilution prepared by diluting “RESEARCH AND TEST PARTICLES Latex Microsphere Suspensions 5200A” manufactured by Duke Scientific Corporation with deionized water). Subsequently, focusing may be carried out every two hours from the start of the measurement.

### EXAMPLES

The present disclosure will now be further specifically described by Manufacturing Examples and Examples, but they do not limit the present disclosure. Incidentally, the parts in the following formulations are all based on mass, unless otherwise specified.

### Manufacturing Example of Electrophotographic Photoreceptor

Manufacturing Examples of electrophotographic photoreceptors 1 to 13 used in Examples will be first described.

### Manufacturing Example of Electrophotographic Photoreceptor 1

### Support

As a support (conductive support), an aluminum cylinder with a length of 357.5 mm, a thickness of 0.7 mm, and an outer diameter of 30 mm was prepared. The prepared aluminum cylinder was subjected to cutting processing of the surface using a lathe.

As the cutting conditions, a cutting tool of R0.1 was used, and processing was performed at a main shaft rotation speed of 10,000 rpm by continuously changing the feed rate of the cutting tool within a range of 0.03 to 0.06 mm/rpm.

### Formation of Undercoat Layer

Zinc oxide particles (average particle diameter: 70 nm, specific surface area value: 15 m²/g, 60 parts) were mixed with tetrahydrofuran (500 parts) with stirring. Consequently, a silane coupling agent (compound name: N-2-(aminoethyl)-3-aminopropyltrimethoxysilane, trade name: KBM603, manufactured by Shin-Etsu Chemical Co., Ltd., 0.75 parts) was added to the mixture, followed by stirring for 2 hours. Subsequently, tetrahydrofuran was distilled off under reduced pressure, and drying by heating at 120° C. for 3 hours was performed to obtain surface-treated zinc oxide particles.

Subsequently, butyral (trade name: BM-1, manufactured by Sekisui Chemical Co., Ltd., 25 parts) as a polyol and blocked isocyanate (trade name: Sumidule BL-3173, manufactured by Sumika Bayer Urethane Co., Ltd., 22.5 parts) were dissolved in methyl ethyl ketone (142 parts). The above surface-treated zinc oxide particles (100 parts) and anthraquinone (1 part) were added to this solution, followed by dispersing with a sand mill using 1 mm diameter glass beads for 5 hours.

After the dispersion treatment, dioctyltin dilaurate (0.008 parts) and silicone resin particles (Tospearl 145, manufactured by GE Toshiba Silicones Co., Ltd., 6.5 parts) were added thereto, followed by stirring to prepare a coating solution for an undercoat layer.

The resulting coating solution for an undercoat layer was dip-coated on the support to form a coating film, and the coating film was dried at 190° C. for 24 minutes to form an undercoat layer having a thickness of 15 μm.

### Formation of Charge Generation Layer

Subsequently, the following materials were mixed and subjected to dispersion treatment with a sand mill using 1 mm diameter glass beads for 4 hours to prepare a coating solution for a charge generation layer.

Hydroxygallium phthalocyanine crystal in a crystal form having strong peaks at Bragg angles 2θ±0.2° of 7.4° and 28.2° in CuKα characteristic X-ray diffraction: 15 parts,

Vinyl chloride-vinyl acetate copolymer resin (trade name: VMCH, manufactured by NUC Corporation): 10 parts, and

Normal-Butyl alcohol: 300 parts.

This coating solution for a charge generation layer was dip-coated on the undercoat layer, and the resulting coating film was dried at 80° C. for 10 minutes to form a charge generation layer having a thickness of 0.2 μm.

### Formation of Charge Transport Layer

The following materials were mixed with stirring while maintaining a solution temperature of 20° C. for 48 hours to obtain a preparation liquid A.

Polytetrafluoroethylene particles (the number-average particle diameter of primary particles, the presence rate of particles with a primary particle diameter of 150 nm or less, the presence rate of particles with a primary particle diameter of 250 nm or more, and the number-average molecular weight are shown in Table 1): 8 parts,

Fluorine-based polymer B (weight-average molecular weight: 105,000, copolymerization ratio m1:m2=1:1) represented by the following formula (P-1): 0.15 parts,

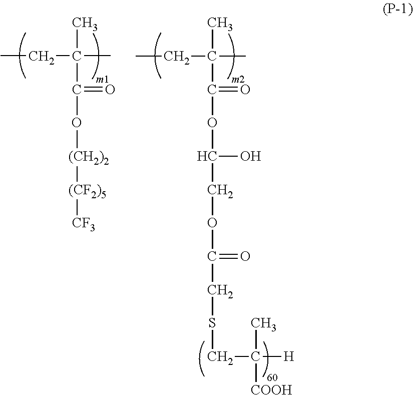

Tetrahydrofuran: 4 parts, and

Toluene: 1 part.

Subsequently, the following materials were mixed and dissolved to form a preparation liquid B.

N,N′-Diphenyl-N,N′-bis(3-methylphenyl)-[1,1]biphenyl-4,4′-diamine: 12 parts, Bisphenol-Z polycarbonate resin (viscosity average molecular weight: 40,000): 12 parts,

Antioxidant: 2,6-di-t-butyl-4-methylphenol: 0.1 parts,

Tetrahydrofuran: 24 parts, and

Toluene: 11 parts.

The preparation liquid A was added to the preparation liquid B, followed by mixing by stirring. The mixture was then applied to a high pressure disperser (trade name: Microfluidizer M-110EH, manufactured by Microfluidics International Corporation) to obtain a dispersion. Subsequently, dimethyl silicone oil (trade name: KP-340, manufactured by Shin-Etsu Silicone) was added to the dispersion at 5 ppm, followed by filtration with a polyflon filter (trade name: PF-040, manufactured by Advantec Toyo Kaisha, Ltd.) to prepare a coating solution for a charge transport layer.

This coating solution for a charge transport layer was dip-coated on the charge generation layer to form a coating film, and the resulting coating film was dried at 115° C. for 50 minutes to form a charge transport layer having a thickness of 40 μm. Thus, an electrophotographic photoreceptor 1 whose charge transport layer is a surface layer was produced.

### Manufacturing Example of Electrophotographic Photoreceptor 2

An electrophotographic photoreceptor 2 was produced by performing the same procedure as in Manufacturing Example of electrophotographic photoreceptor 1 except that the fluorine-based polymer B in Manufacturing Example of electrophotographic photoreceptor 1 was changed to a fluorine-based polymer (weight-average molecular weight: 103,500, copolymerization ratio m1:m2=1:1) represented by the following formula (P-2) and that the polytetraethylene particles were changed to the particles shown in Table 1.

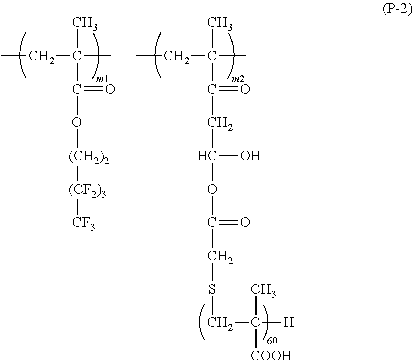

### Manufacturing Example of Electrophotographic Photoreceptor 3

An electrophotographic photoreceptor 3 was produced by performing the same procedure as in Manufacturing Example of electrophotographic photoreceptor 1 except that the fluorine-based polymer B in Manufacturing Example of electrophotographic photoreceptor 1 was changed to a fluorine-based polymer (weight-average molecular weight: 103,000, copolymerization ratio m1:m2=1:1) represented by the following formula (P-3).

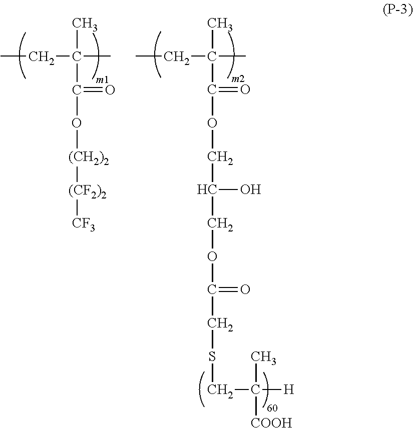

### Manufacturing Example of Electrophotographic Photoreceptor 4

An electrophotographic photoreceptor 4 was produced by performing the same procedure as in Manufacturing Example of electrophotographic photoreceptor 1 except that the fluorine-based polymer B in Manufacturing Example of electrophotographic photoreceptor 1 was changed to a fluorine-based polymer (weight-average molecular weight: 107,000, copolymerization ratio m1:m2=1:1) represented by the following formula (P-4).

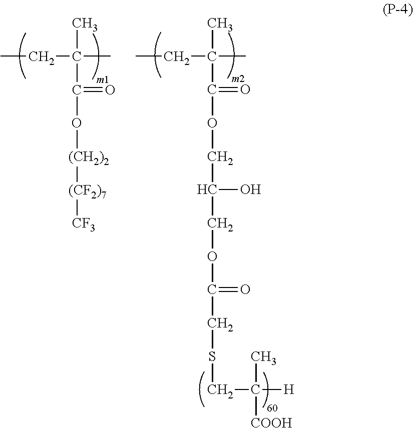

### Manufacturing Example of Electrophotographic Photoreceptors 5 to 9

Electrophotographic photoreceptors 5 to 9 were produced by performing the same procedure as in Manufacturing Example of electrophotographic photoreceptor 1 except that the polytetraethylene particles in Manufacturing Example of electrophotographic photoreceptor 1 were changed to particles shown in Table 1.

### Manufacturing Example of Electrophotographic Photoreceptor 10

An undercoat layer and a charge generation layer were formed on a support by the same method as in Manufacturing Example of electrophotographic photoreceptor 1.

### Formation of Charge Transport Layer

The following materials were mixed and dissolved to obtain a coating solution for a charge transport layer.

N,N′-diphenyl-N,N′-bis(3-methylphenyl)-[1,1′]biphenyl-4,4′-diamine: 8 parts,

Bisphenol-Z polycarbonate resin (viscosity average molecular weight: 40,000): 12 parts,

Antioxidant: 2,6-di-t-butyl-4-methylphenol: 0.1 parts,

Tetrahydrofuran: 24 parts, and

Toluene: 11 parts.

This coating solution for a charge transport layer was dip-coated on the charge generation layer to form a coating film, and the resulting coating film was dried at 115° C. for 50 minutes to form a charge transport layer having a thickness of 20 μm.

Formation of Protective Layer

The following materials were mixed by stirring. The mixture was then applied to a high pressure disperser (trade name: Microfluidizer M-110EH, manufactured by Microfluidics International Corporation) to obtain a dispersion.

Polytetrafluoroethylene particles (the number-average particle diameter of primary particles, the presence rate of particles with a primary particle diameter of 150 nm or less, the presence rate of particles with a primary particle diameter of 250 nm or more, and the number-average molecular weight are shown in Table 1): 8 parts,

Fluorine-based polymer B (weight-average molecular weight: 105,000,

copolymerization ratio m1:m2=1:1) represented by the formula (P-1): 0.20 parts, and

Cyclopentanone: 15 parts.

Subsequently, a charge transport compound (18 parts) represented by the following formula (4), a melamine compound (1 part) represented by the following formula (5), cyclopentanone (10 parts), and NACURE 5225 (manufactured by King Industries, Inc., 0.04 parts) were mixed and dissolved to obtain a preparation liquid.

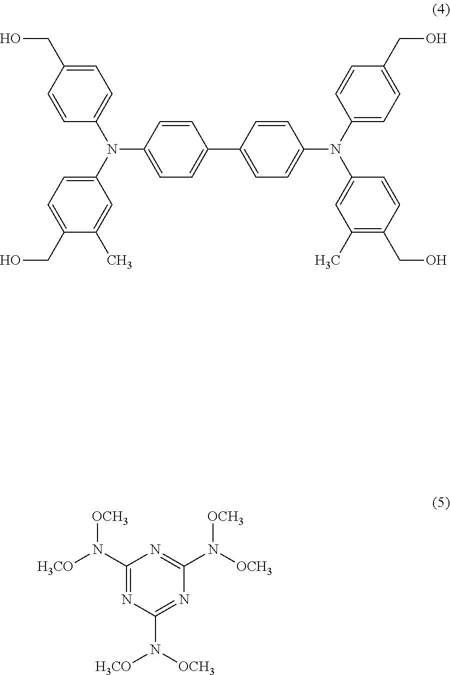 [SMILES: Cc1cc(N(c2ccc(CO)cc2)c2ccc(-c3ccc(N(c4ccc(CO)cc4)c4ccc(CO)c(C)c4)cc3)cc2)ccc1CO ; CON(OC)c1nc(N(OC)OC)nc(N(OC)OC)n1]

The dispersion was added to this preparation liquid, followed by mixing by stirring. The mixture was filtered through a polytetrafluoroethylene filter (trade name: PF-040, manufactured by Advantec Toyo Kaisha, Ltd.) to prepare a coating solution for a surface layer. This coating solution was dip-coated on the charge transport layer, and the resulting coating film was heat-treated at 150° C. for 60 minutes to form a surface layer having a thickness of 4.8 μm. Thus, an electrophotographic photoreceptor 10 was produced.

### Manufacturing Example of Electrophotographic Photoreceptor 11

An electrophotographic photoreceptor 11 was produced by performing the same procedure as in Manufacturing Example of electrophotographic photoreceptor 10 except that the fluorine-based polymer B in Manufacturing Example of electrophotographic photoreceptor 10 was changed to a fluorine-based polymer (weight-average molecular weight: 107,000, copolymerization ratio m1:m2=1:1) represented by the formula (P-4).

### Manufacturing Example of Electrophotographic Photoreceptor 12

An undercoat layer, a charge generation layer, and a charge transport layer were formed on a support by the same method as in Manufacturing Example of electrophotographic photoreceptor 10.

### Formation of Protective Layer

The following materials were mixed by stirring. The mixture was then applied to a high pressure disperser (trade name: Microfluidizer M-110EH, manufactured by Microfluidics International Corporation) to obtain a dispersion.

Polytetrafluoroethylene particles (the number-average particle diameter of primary particles, the presence rate of particles with a primary particle diameter of 150 nm or less, the presence rate of particles with a primary particle diameter of 250 nm or more, and the number-average molecular weight are shown in Table 1): 8 parts,

Fluorine-based polymer B (weight-average molecular weight: 105,000, copolymerization ratio m1:m2=1:1) represented by the formula (P-1): 0.20 parts,

1,1,2,2,3,3,4-Heptafluorocyclopentane: 12 parts, and

1-Propanol: 17 parts.

Subsequently, a compound represented by the following formula (6) (20 parts), 1-propanol (5 parts), and 1,1,2,2,3,3,4-heptafluorocyclopentane (5 parts) were mixed and dissolved to obtain a preparation liquid.

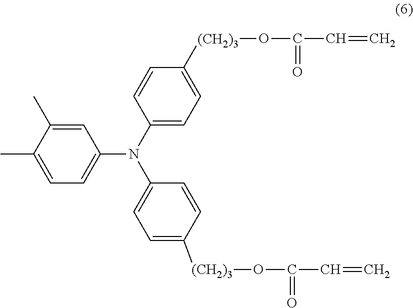

The dispersion was added to this preparation liquid, followed by mixing by stirring. The mixture was filtered through a polytetrafluoroethylene filter (trade name: PF-040, manufactured by Advantec Toyo Kaisha, Ltd.) to prepare a coating solution for a surface layer. This coating solution was dip-coated on the charge transport layer, and the resulting coating film was heat-treated at 50° C. for 5 minutes.

After the heat treatment, the coating film was irradiated with an electron beam while rotating the cylinder in a nitrogen atmosphere under conditions of an acceleration voltage of 70 kV and an absorbed dose of 5,000 Gy for 1.6 seconds to cure the coating film. Subsequently, heat treatment was performed in a nitrogen atmosphere for 25 seconds under the condition that the coating film became 130° C. The oxygen concentration during from the irradiation with an electron beam until the heat treatment for 25 seconds was 18 ppm. Subsequently, heat treatment was performed in the air for 15 minutes under the condition that the coating film became 110° C. to form a surface layer having a thickness of 5.0 μm. Thus, an electrophotographic photoreceptor 12 was produced.

### Manufacturing Example of Electrophotographic Photoreceptor 13

An electrophotographic photoreceptor 13 was produced by performing the same procedure as in Manufacturing Example of electrophotographic photoreceptor 12 except that the fluorine-based polymer B in Manufacturing Example of electrophotographic photoreceptor 12 was changed to a fluorine-based polymer (weight-average molecular weight: 107,000, copolymerization ratio m1:m2=1:1) represented by the formula (P-4).

TABLE 1

| | Fluorine-based polymer B | | | Polytetrafluoroethylene particles | | | |
|---|---|---|---|---|---|---|---|
| | | | | Number- | | | |
| | | | | average | Presence rate | | |
| | | | | particle | Primary | Primary | |
| | | | Weight- | diameter | particle | particle | Number- |
| | | nf in | average | of | diameter | diameter | average |
| | Structural | Formula | molecular | primary | of 150 nm | of 250 nm | molecular |
| | formula | (1) | weight | particle | or less | or more | weight |
| Electrophotographic | (P-1) | 5 | 105000 | 180 nm | 20% | 2% | 16000 |
| photoreceptor 1 | | | | | | | |
| Electrophotographic | (P-2) | 3 | 103500 | 180 nm | 20% | 2% | 20000 |
| photoreceptor 2 | | | | | | | |
| Electrophotographic | (P-3) | 2 | 103000 | 180 nm | 20% | 2% | 16000 |
| photoreceptor 3 | | | | | | | |
| Electrophotographic | (P-4) | 7 | 107000 | 180 nm | 20% | 2% | 16000 |
| photoreceptor 4 | | | | | | | |
| Electrophotographic | (P-1) | 5 | 105000 | 150 nm | 60% | 0% | 11000 |
| photoreceptor 5 | | | | | | | |
| Electrophotographic | (P-1) | 5 | 105000 | 195 nm | 10% | 5% | 11000 |
| photoreceptor 6 | | | | | | | |
| Electrophotographic | (P-1) | 5 | 105000 | 200 nm | 10% | 5% | 25000 |
| photoreceptor 7 | | | | | | | |
| Electrophotographic | (P-1) | 5 | 105000 | 200 nm | 0% | 15% | 25000 |
| photoreceptor 8 | | | | | | | |
| Electrophotographic | (P-1) | 5 | 105000 | 130 nm | 70% | 0% | 20000 |
| photoreceptor 9 | | | | | | | |
| Electrophotographic | (P-1) | 5 | 105000 | 180 nm | 20% | 2% | 16000 |
| photoreceptor 10 | | | | | | | |
| Electrophotographic | (P-4) | 7 | 107000 | 180 nm | 20% | 2% | 16000 |
| photoreceptor 11 | | | | | | | |
| Electrophotographic | (P-1) | 5 | 105000 | 180 nm | 20% | 2% | 16000 |
| photoreceptor 12 | | | | | | | |
| Electrophotographic | (P-4) | 7 | 107000 | 180 nm | 20% | 2% | 16000 |
| photoreceptor 13 | | | | | | | |

The weight-average molecular weight of fluorine-based polymer B and the number-average particle diameter, presence rates, and number-average molecular weight of polytetrafluoroethylene particles in Table 1 were measured by the above-described measurement methods.

### Two-Component Developer

Subsequently, Manufacturing Examples of two-component developers 1 to 8 used in each Example will be described.

### Manufacturing Example of Two-Component Developer 1

### Manufacturing Example of Resin A1

Toluene: 150.0 parts

Behenyl acrylate: 48.0 parts

(80.0 mass %)

Acrylic acid: 12.0 parts

Polymerization initiator: azoisobutyronitrile (AIBN): 1.5 parts

The above-mentioned materials were charged in a reaction vessel equipped with a reflux condenser tube, a stirrer, a thermometer, and a nitrogen inlet tube in a nitrogen atmosphere. The inside of the reaction vessel was heated to 70° C. while stirring at 200 rpm for 12 hours to perform a polymerization reaction to obtain a solution in which a polymer of a monomer composition was dissolved in toluene. Subsequently, the solution was cooled to 25° C. and was then charged into a 1,000.0 parts of methanol while stirring to precipitate methanol-insoluble matter. The resulting methanol-insoluble matter was separated by filtration, further washed with methanol, and then vacuum-dried at 40° C. for 24 hours to obtain a resin A1.

### Manufacturing Example of Resin A1 Dispersion

Toluene (manufactured by FUJIFILM Wako Pure Chemical Corporation):

300 parts

Resin A1:100 parts

The above-mentioned materials were weighed, mixed, and melted at 90° C. to obtain a toluene solution.

Separately, sodium dodecylbenzenesulfonate (2.0 parts) and sodium laurate (4.0 parts) were added to deionized water (700 parts) and were heated and dissolved at 90° C. Subsequently, the toluene solution and the aqueous solution were mixed with each other and stirred using an ultra-high speed stirrer T.K. Robomix (manufactured by PRIMIX Corporation) at 7000 rpm. Furthermore, emulsification was performed using a high-pressure impact disperser Nanomizer (manufactured by Yoshida Kikai Co., Ltd.) at a pressure of 200 MPa. Subsequently, toluene was removed using an evaporator, and the concentration was adjusted with deionized water to obtain an aqueous dispersion containing 20 mass % of the resin A1 (resin A1 dispersion).

### Manufacturing Example of Resin B

Xylene: 100.0 parts

Styrene: 100.0 parts

Normal-butyl acrylate: 10.0 parts

Acrylic acid: 1.5 parts

Dodecanethiol: 6.0 parts

Carbon tetrabromide: 1.0 parts

The above-mentioned materials were charged in a reaction vessel equipped with a reflux condenser tube, a stirrer, a thermometer, and a nitrogen inlet tube in a nitrogen atmosphere. The inside of the reaction vessel was heated to 185° C. while stirring at 200 rpm for 10 hours to perform a polymerization reaction. Subsequently, the solvent was removed, and vacuum drying was performed at 40° C. for 24 hours to obtain a resin B.

### Manufacturing Example of Resin B Dispersion

Tetrahydrofuran (manufactured by FUJIFILM Wako Pure Chemical Corporation): 300 parts

Resin B: 100 parts

Anionic surfactant Neogen RK (manufactured by DKS Co., Ltd.): 0.5 parts

The above-mentioned materials were weighed, mixed, and melted.

Subsequently, 1 mol/L ammonia water (20.0 parts) was added thereto, followed by stirring with an ultra-high speed stirrer T.K. Robomix (manufactured by PRIMIX Corporation) at 4000 rpm. Furthermore, deionized water (700 parts) was added thereto at a rate of 8 g/min to deposit the resin B. Subsequently, tetrahydrofuran was removed using an evaporator, and the concentration was adjusted with deionized water to obtain an aqueous dispersion containing 20 mass % of the resin B (resin B dispersion). Manufacturing Example of release agent microparticle dispersion

Aliphatic hydrocarbon compound HNP-51 (manufactured by Nippon Seiro Co., Ltd.): 120 parts

Anionic surfactant Neogen RK (manufactured by DKS Co., Ltd.): 6 parts

Deionized water: 400 parts

The above-mentioned materials were weighed and charged in a mixing vessel equipped with a stirrer and then heated to 90° C., and dispersion treatment was performed for 60 minutes by circulation to Clearmix W-Motion (manufactured by M Technique Co., Ltd.). The conditions of the dispersion treatment were as follows:

Rotor outer diameter: 3 cm,

Clearance: 0.3 mm,

Rotor rotation speed: 19,000 r/min, and

Screen rotation speed: 19,000 r/min.

After the dispersion treatment, cooling to 40° C. was performed under cooling treatment conditions of a rotor rotation speed of 1,000 r/min, a screen rotation speed of 0 r/min, and a cooling rate of 10° C./min to obtain an aqueous dispersion containing 20 mass % of a release agent (release agent dispersion).

### Manufacturing of Coloring Agent Microparticle Dispersion

Cyan pigment (Pigment Blue 15:3, manufactured by Dainichiseika Color & Chemicals Mfg. Co., Ltd.): 50.0 parts

Anionic surfactant Neogen RK (manufactured by DKS Co., Ltd.): 7.5 parts Deionized water: 442.5 parts.

The above-mentioned materials were weighed, mixed, and melted, followed by dispersing with a high-pressure impact disperser Nanomizer (manufactured by Yoshida Kikai Co., Ltd.) for about 1 hour to obtain an aqueous dispersion containing 10 mass % of the coloring agent microparticles (coloring agent microparticle dispersion) dispersing the coloring agent.

### Manufacturing Example of Toner 1

Resin A1 dispersion: 500 parts

Resin B dispersion: 120 parts

Release agent dispersion: 50 parts

Coloring agent microparticle dispersion: 80 parts

Deionized water: 160 parts

The above-mentioned materials were charged in a round stainless steel flask and were mixed, and a 10% magnesium sulfate aqueous solution (10 parts) was added thereto. Subsequently, dispersing was performed with a homogenizer Ultra-Turrax T50 (manufactured by IKA) at 5,000 r/min for 10 minutes. Subsequently, the mixture liquid was heated to 58° C. in a heating water bath while appropriately controlling the rotation speed of the stirring blade such that the mixture liquid could be stirred.

The volume-average particle diameters of the formed aggregated particles were appropriately verified using Coulter Multisizer III, and at the time when formation of aggregated particles having a volume-average particle diameter of about 6.00 μm was observed, sodium ethylenediaminetetraacetate (100 parts) was added thereto. Subsequently, heating to 75° C. was performed while continuing the stirring. The aggregated particles were then fused by holding the particles at 75° C. for 1 hour.

Subsequently, cooling to 50° C. was performed, and the temperature was maintained for 3 hours to facilitate crystallization of the polymer.

Furthermore, subsequently, cooling to 25° C., filtration and solid-liquid separation, and then washing with deionized water were performed. After the washing, drying using a vacuum dyer was performed to obtain a toner particle 1 having a weight-average particle diameter (D4) of 6.05 μm. The content rate of the resin A1 in the toner particle 1 was 70.4 mass %.

Subsequently, the following materials were mixed with a Henschel mixer FM-10C type (manufactured by Mitsui Miike Kakoki K.K.) at a rotation speed of 30 s⁻¹ and a rotation time of 10 minutes to obtain a toner 1.

Toner particle 1:100 parts,

Silica microparticles having an average particle diameter of 130 nm and surface-treated with hexamethyldisilazane: 3 parts, and

Silica microparticles having an average particle diameter of 20 nm and surface-treated with hexamethyldisilazane: 1 part.

The toner 1 had a weight-average particle diameter (D4) of 6.1 μm, an average circularity of 0.975, and a softening point of 85° C.

### Manufacturing Example of Magnetic Carrier

Magnetite 1 having a number-average particle diameter of 0.30 μm (a magnetization strength of 65 Am2/kg under a magnetic field of 1,000/4π (kA/m)), and

Magnetite 2 having a number-average particle diameter of 0.50 μm (a magnetization strength of 65 Am2/kg under a magnetic field of 1,000/4π (kA/m))

A silane compound (3-(2-aminoethylaminopropyl)trimethoxysilane, 4.0 parts) was added to each of the above-mentioned materials (each 100 parts), and the mixtures were subjected to high-speed mixing and stirring in the respective containers at 100° C. or more to treat the respective microparticles.

Phenol: 10 mass %

Formaldehyde solution: 6 mass %

(Formaldehyde: 40 mass %, Methanol: 10 mass %, and water: 50 mass %)

Magnetite 1 treated with the silane compound: 58 mass %

Magnetite 2 treated with the silane compound: 26 mass %

The above-mentioned materials (100 parts), a 28 mass % ammonia aqueous solution (5 parts), and water (20 parts) were placed in a flask and were heated to 85° C. over 30 minutes while stirring and mixing, followed by a polymerization reaction by retaining the temperature for 3 hours to cure the generated phenol resin.

Subsequently, the cured phenol resin was cooled to 30° C., and water was further added thereto. The supernatant was removed, and the precipitate was washed with water and then air dried. Subsequently, the air dried precipitate was dried under reduced pressure (5 mmHg or less) at a temperature of 60° C. to obtain a magnetic material dispersion-type spherical magnetic carrier 1. The 50% particle diameter (D50) on a volume basis was 34.21 μm.

### Two-Component Developer 1

The magnetic carrier 1 (92.0 parts) and the toner 1 (8.0 parts) were mixed with a V-shape mixer (V-20, manufactured by Seishin Enterprise Co., Ltd.) to obtain a two-component developer 1.

### Manufacturing Examples of Two-Component Developers 2 to 8

Toners 2 to 8 were obtained by performing the same procedure as in Manufacturing Example of two-component developer 1 except that the resin A1 was changed to the resin A shown in Table 2, and then two-component developers 2 to 8 were prepared. Manufacturing Examples of resins A2 to A8 will be shown below. Table 3 shows the weight-average particle diameter (D4), average circularity, and toner softening point (Tm) of each of the toners 1 to 8.

TABLE 2

| | | | | Number | Rate of |
|---|---|---|---|---|---|
| | | | | of carbon | unit A1 in |
| | Toner | Resin A | | atoms | resin A |
| | Type | Type | Unit A1 | of R^{Z2} | mass % |
| Two-component | Toner 1 | Resin A1 | Behenyl | 22 | 80.0 |
| developer 1 | | | acrylate | | |
| Two-component | Toner 2 | Resin A2 | Behenyl | 22 | 80.0 |
| developer 2 | | | meth- | | |
| | | | acrylate | | |
| Two-component | Toner 3 | Resin A3 | Stearyl | 18 | 80.0 |
| developer 3 | | | acrylate | | |
| Two-component | Toner 4 | Resin A4 | Acrylic | 36 | 80.0 |
| developer 4 | | | acid | | |
| | | | hexatria- | | |
| | | | contane | | |
| Two-component | Toner 5 | Resin A5 | Acrylic | 38 | 80.0 |
| developer 5 | | | acid | | |
| | | | octatria- | | |
| | | | contane | | |
| Two-component | Toner 6 | Resin A6 | Behenyl | 22 | 100.0 |
| developer 6 | | | acrylate | | |
| Two-component | Toner 7 | Resin A7 | Behenyl | 22 | 50.0 |
| developer 7 | | | acrylate | | |
| Two-component | Toner 8 | Resin A8 | Behenyl | 22 | 20.0 |
| developer 8 | | | acrylate | | |

### Manufacturing Example of Resin A2

Resin A2 was manufactured by performing the same procedure as in Manufacturing Example of resin A1 except that behenyl methacrylate was used instead of behenyl acrylate and that methacrylic acid was used instead of acrylic acid.

### Manufacturing Example of Resin A3

Resin A3 was manufactured by performing the same procedure as in Manufacturing Example of resin A1 except that stearyl acrylate was used instead of behenyl acrylate.

### Manufacturing Example of Resin A4

Resin A4 was manufactured by performing the same procedure as in Manufacturing Example of resin A1 except that acrylic acid hexatriacontane (the number of carbon atoms of the alkyl group is 36) was used instead of behenyl acrylate.

### Manufacturing Example of Resin A5

Resin A5 was manufactured by performing the same procedure as in Manufacturing Example of resin A1 except that acrylic acid octatriacontane (the number of carbon atoms of the alkyl group is 38) was used instead of behenyl acrylate.

### Manufacturing Example of Resin A6

Resin A6 was manufactured by performing the same procedure as in Manufacturing Example of resin A1 except that the amount of behenyl acrylate was changed to 60.0 parts and that acrylic acid was not used.

### Manufacturing Example of Resin A7

Resin A7 was manufactured by performing the same procedure as in Manufacturing Example of resin A1 except that the amount of behenyl acrylate was changed to 30.0 parts and that the amount of acrylic acid was changed to 30.0 parts.

### Manufacturing Example of Resin A8

Resin A8 was manufactured by performing the same procedure as in Manufacturing Example of resin A1 except that the amount of behenyl acrylate was changed to 12.0 parts and that the amount of acrylic acid was changed to 48.0 parts.

TABLE 3

| | Weight-average particle | Average | Toner softening |
|---|---|---|---|
| | diameter (D4) | circularity | point (Tm) |
| Toner 1 | 6.1 μm | 0.975 | 85° C. |
| Toner 2 | 6.0 μm | 0.965 | 88° C. |
| Toner 3 | 6.1 μm | 0.982 | 75° C. |
| Toner 4 | 6.2 μm | 0.978 | 95° C. |
| Toner 5 | 6.1 μm | 0.978 | 100° C. |
| Toner 6 | 6.0 μm | 0.980 | 86° C. |
| Toner 7 | 6.2 μm | 0.975 | 90° C. |
| Toner 8 | 6.1 μm | 0.978 | 92° C. |

The values in Table 3 were measured by the above-described measurement methods.

### Example 1

The following evaluation was performed using the two-component developer 1 and the electrophotographic photoreceptor 1 described above. Evaluation of image streaks

As an image forming apparatus, a modified machine of a copying machine (trade name: iR-ADV-05255, manufactured by CANON KABUSHIKI KAISHA) was used. In the evaluation, assuming high-speed image output, the modification was performed such that the control action before image output is not performed and thereby the electrophotographic photoreceptor does not rotate in a state of abutting on the cleaning blade before image output. The evaluation was performed in an environment of a temperature of 32.5° C. and a relative humidity of 85% RH.

The electrophotographic photoreceptor 1 obtained above was mounted on the cyan station of the evaluation machine.

Here, the cleaning blade of the electrophotographic photoreceptor used was a polyurethane rubber cleaning blade having a hardness of 77° and was set so as to abut on the peripheral surface of the electrophotographic photoreceptor with a contact angle of 28° and a contact pressure of 30 g/cm (29.4 N/m).

Subsequently, the two-component developer 1 was put in the development unit of the cyan station of the evaluation machine and was set to the evaluation machine. In addition, the conditions of the charging device and exposure device were set in advance such that the dark part potential (Vd) of the electrophotographic photoreceptor was −500 v and the bright part potential (Vl) was −200 v.

Subsequently, half-tone images having an image density of 30% were continuously output on 10 sheets of A4 size with the heater (drum heater) for the electrophotographic photoreceptor turned ON. The output ten images were evaluated according to the following evaluation criteria, and the one with the lowest evaluation among the 10 sheets was used as the evaluation result.

Evaluation Criteria

A: no streaks are observed on the image,

B: although the image is suspected to have a streak on the image, the level thereof remains to be too low to determine whether it is a streak,

C: very light streaks are observed on the image, and

D: clear streaks are observed on the image.

### Examples 2 to 20 and Comparative Examples 1 to 9

Image streaks were evaluated by performing the same procedure as in Example 1 except that the two-component developer 1 and the electrophotographic photoreceptor 1 were changed to the two-component developers and electrophotographic photoreceptors shown in Table 4. The evaluation results are shown in Table 4. Reference Examples 1 to 4 are described later.

TABLE 4

| | Electrophotographic | Two-component | Evaluation result |
|---|---|---|---|
| | photoreceptor | developer | of image streak |
| Example 1 | 1 | 1 | A |
| Example 2 | 2 | 1 | A |
| Example 3 | 3 | 1 | A |
| Example 4 | 1 | 2 | A |
| Example 5 | 1 | 3 | B |
| Example 6 | 2 | 3 | A |
| Example 7 | 3 | 3 | A |
| Example 8 | 1 | 4 | B |
| Example 9 | 2 | 4 | B |
| Example 10 | 3 | 4 | B |
| Example 11 | 1 | 6 | B |
| Example 12 | 1 | 7 | A |
| Example 13 | 1 | 8 | A |
| Example 14 | 5 | 1 | B |
| Example 15 | 6 | 1 | B |
| Example 16 | 7 | 1 | B |
| Example 17 | 8 | 1 | C |
| Example 18 | 9 | 1 | C |
| Example 19 | 10 | 1 | A |
| Example 20 | 12 | 1 | A |
| Comparative | 4 | 1 | D |
| Example 1 | | | |
| Comparative | 4 | 8 | D |
| Example 2 | | | |
| Comparative | 4 | 3 | D |
| Example 3 | | | |
| Comparative | 4 | 4 | D |
| Example 4 | | | |
| Comparative | 1 | 5 | D |
| Example 5 | | | |
| Comparative | 2 | 5 | D |
| Example 6 | | | |
| Comparative | 3 | 5 | D |
| Example 7 | | | |
| Comparative | 11 | 1 | D |
| Example 8 | | | |
| Comparative | 13 | 1 | D |
| Example 9 | | | |
| Reference | 4 | 9 | A |
| Example 1 | | | |
| Reference | 1 | 9 | A |
| Example 2 | | | |
| Reference | 2 | 9 | A |
| Example 3 | | | |
| Reference | 3 | 9 | A |
| Example 4 | | | |

### Manufacturing Example of Two-Component Developer 9 to be Used in Reference Examples

### Manufacturing Example of Crystalline Polyester Resin C

Dodecanedioic acid: 50 parts by mol

1,6-Hexanediol: 50 parts by mol

Octadecanoic acid: 5 parts by mol

The above-mentioned materials and tin(II) octylate in an amount of 0.5 parts with respect to 100 parts of the mass of the above-mentioned materials were charged in a reaction tank equipped with a condenser tube, a stirrer, a nitrogen inlet tube, and a thermocouple. The temperature was gradually increased to 160° C. while stirring in a nitrogen atmosphere, and a reaction was performed at 160° C. for 5 hours while stirring.

Subsequently, the pressure in the reaction tank was decreased to 8.3 kPa, the temperature was increased to 200° C., and a reaction was performed for 4 hours (first reaction process). Subsequently, the pressure in the reaction tank was gradually released to the normal pressure, dodecanoic acid was then added thereto in an amount of 5.0 parts by mol with respect to 100 parts by mol of the total amount of the raw material carboxylic acid component and alcohol component, and a reaction was performed under the normal pressure at 200° C. for 2 hours. Subsequently, the pressure inside the reaction tank was reduced again to 5 kPa or less, and a reaction was performed at 200° C. for 3 hours to obtain a crystalline polyester resin C (second reaction process).

### Manufacturing Example of Amorphous Polyester Resin D

A 5-L four-necked flask equipped with a nitrogen inlet tube, a condenser tube, a stirrer, and a thermocouple was replaced with nitrogen, and the following materials were then charged therein.

Propylene oxide adduct of bisphenol A (average number of moles added: 2.7): 60 parts by mol,

Terephthalic acid: 40 parts by mol, and

Tin(II) octylate: 0.5 parts.

The temperature was increased to 180° C., and a reaction was then performed for 10 hours. The reaction was further performed at 15 mmHg for 5 hours (first reaction process), and then as a second reaction process, 0.04 parts by mol of trimellitic anhydride was added, and a reaction was performed at 180° C. for 3 hours to obtain an amorphous polyester resin D.

### Manufacturing Example of Amorphous Polyester Resin E

A 5-L four-necked flask equipped with a nitrogen inlet tube, a condenser tube, a stirrer, and a thermocouple was replaced with nitrogen, and the following materials were then charged therein.

Propylene oxide adduct of bisphenol A (average number of moles added: 2.7): 57 parts by mol,

Ethylene oxide adduct of bisphenol A (average number of moles added: 2.0): 3 parts by mol,

Terephthalic acid: 40 parts by mol, and

Tin(II) octylate: 0.5 parts.

The temperature was increased to 180° C., and a reaction was then performed for 10 hours. The reaction was further performed at 15 mmHg for 5 hours (first reaction process), and then as a second reaction process, 0.04 parts by mol of trimellitic anhydride was added, and the reaction was stopped after confirmation that the softening point reached 135° C. to obtain an amorphous polyester resin E.

The amorphous polyester resins D and E are summarized in Table 5.

TABLE 5

| | Alcohol component | | | Carboxylic acid component | | | | | |
|---|---|---|---|---|---|---|---|---|---|
| | First reaction process | | | First reaction | | Second reaction | | Physical property | |
| | Monomer | | | process | | process | | Glass | |
| | | Average | | Monomer | | Monomer | | transition | Softening |
| Amorphous | | number | Parts | | Part | | Part | temperature | point |
| polyester | | of moles | by | | by | | by | Tg | Tm |
| resin | Type | added | mol | Type | mol | Type | mol | [° C.] | [° C.] |
| D | BPA-PO | 2.7 | 60 | TPA | 40 | TMA | 0.04 | 50 | 82 |
| | | | | | | anhydride | | | |
| E | BPA-PO | 2.7 | 57 | TPA | 40 | TMA | 0.04 | 60 | 135 |
| | BPA-EO | 2.0 | 3 | | | anhydride | | | |

In Table 4, the meanings of the abbreviations are as follows:

BPA-PO: propylene oxide adduct of bisphenol A;

BPA-EO: ethylene oxide adduct of bisphenol A;

TPA: terephthalic acid; and

TMA anhydride: trimellitic acid anhydride.

### Manufacturing Example of Toner 9

Crystalline polyester resin C: 15.0 parts

Amorphous polyester resin D: 62.5 parts

Amorphous polyester resin E: 30.0 parts

Hydrocarbon wax (FNP0090, manufactured by Nippon Seiro Co., Ltd.): 5.0 parts

Cyan pigment (Pigment Blue 15:3, manufactured by Dainichiseika Color & Chemicals Mfg. Co., Ltd.): 7.0 parts

Aluminum 3,5-di-t-butylsalicylate compound: 0.3 parts

The above-mentioned materials were mixed using a Henschel mixer (FM-75 type, manufactured by Nippon Coke & Engineering Co., Ltd.) at a rotation speed of 20 s⁻¹ and a rotation time of 5 minutes and were then melted and kneaded with a biaxial kneader (PCM-30 type, manufactured by Ikegai Corporation) set to a temperature of 145° C.

The resulting kneaded mixture was cooled and roughly pulverized to 1 mm or less with a hammer mill to obtain a cracked product. The resulting cracked product was finely pulverized with a mechanical pulverizer (T-250, manufactured by Freund-Turbo Corporation). Furthermore, classification was performed using Faculty F-300 (manufactured by Hosokawa Micron Corporation) to obtain toner particles 9.

The toner particles 9 (100 parts), hydrophobic silica microparticles surface-treated with hexamethyldisilazane (BET: 200 m²/g, 1.0 parts), and titanium oxide microparticles surface-treated with isobutyltrimethoxysilane (BET: 80 m²/g, 1.0 parts) were mixed with a Henschel mixer (FM-75 type, manufactured by Mitsui Miike Kakoki K.K.) at a rotation speed of 30 s⁻¹ and a rotation time of 10 minutes to obtain a toner 9.

The toner 9 had a weight-average particle diameter (D4) of 6.2 μm, an average circularity of 0.950, and a softening point (Tm) of 98° C.

### Two-Component Developer 9

The magnetic carrier 1 (92.0 parts) used in Example 1 and the toner 9 (8.0 parts) were mixed with a V-shape mixer (V-20, manufactured by Seishin Enterprise Co., Ltd.) to obtain a two-component developer 9.

### Reference Examples 1 to 4

Image streaks were evaluated by performing the same procedure as in Example 1 except that the two-component developer 1 and the electrophotographic photoreceptor 1 were changed to the two-component developer 9 and the electrophotographic photoreceptors shown in Table 4.

The evaluation results are shown in Table 4.

It was revealed by Reference Examples 1 to 4 that a toner not containing the resin A but containing a crystalline polyester does not cause the disadvantages to be overcome by the present disclosure. The present inventors infer that this is caused by that since a crystalline polyester forms a crystalline site by aggregation at the main chain part of the polymer, the formed crystalline site is unlikely to become dense, and the slipperiness of the toner is unlikely to increase.

According to an aspect of the present disclosure, it is possible to provide an image forming method that is unlikely to form image streaks in output images.

In addition, according to another aspect of the present disclosure, it is possible to provide a process cartridge that is used in the image forming method according to the present disclosure.

In addition, according to another aspect of the present disclosure, it is possible to provide an image forming apparatus that is used in the image forming method according to the present disclosure.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2021-096905, filed Jun. 9, 2021, which is hereby incorporated by reference herein in its entirety.

What is claimed is:

1. An image forming method comprising:
a charging step of charging a surface of an electrophotographic photoreceptor;
an image exposure step of irradiating the charged surface of the electrophotographic photoreceptor with image exposure light to form an electrostatic latent image on the surface of the electrophotographic photoreceptor;
a developing step of developing the electrostatic latent image with a toner to form a toner image on the surface of the electrophotographic photoreceptor;
a transferring step of transferring the toner image from the surface of the electrophotographic photoreceptor onto a transfer material;
a cleaning step of removing the toner remaining on the surface of the electrophotographic photoreceptor with a cleaning blade after the transferring step; and
a fixing step of fixing the toner image transferred to the transfer material to the transfer material, wherein
the toner contains toner particles,
the toner particles contain a resin A including a unit A1 represented by formula (1): 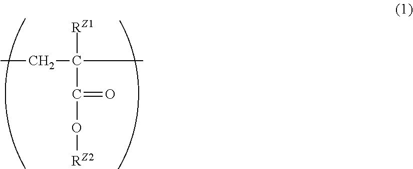
in the formula (1), R^{Z1} represents a hydrogen atom or a methyl group; and R^{Z2} represents an alkyl group having 18 to 36 carbon atoms, and
the electrophotographic photoreceptor includes a surface layer containing:
(i) fluorine-containing resin particles; and
(ii) a fluorine-based polymer B including a unit B1 represented by formula (2) and a unit B2 represented by formula (3): 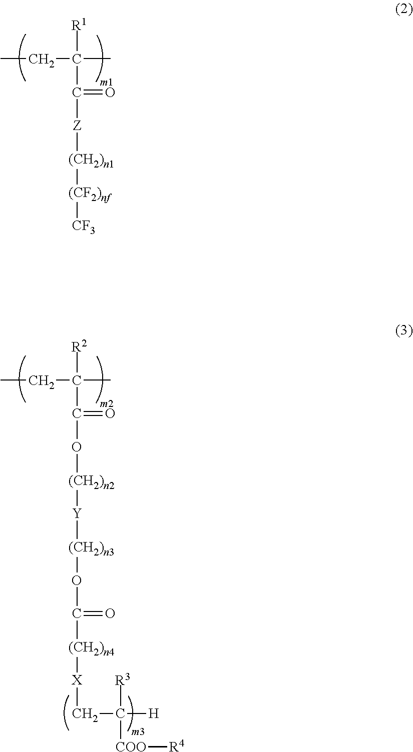
in the formulae (2) and (3), R¹, R², R³, and R⁴ each independently represent a hydrogen atom or an alkyl group; X represents an alkylene group, a halogen-substituted alkylene group, —S—, —O—, —NH—, or a single bond; Y represents an alkylene group, a halogen-substituted alkylene group, an alkylene group including a hydroxy group, or a single bond; Z represents —O— or —NH—; m1, m2, and m3 each independently represent an integer of 1 or more; n1, n2, n3, and n4 each independently represent an integer of 0 or more; and of represents an integer of 1 to 5.

2. The image forming method according to claim 1, wherein in formula (2), of is 2 or 3.

3. The image forming method according to claim 1, wherein
the fluorine-containing resin particles are polytetrafluoroethylene particles,
primary particles of the polytetrafluoroethylene particles have a number-average particle diameter of 150 nm or more and 195 nm or less,
in the polytetrafluoroethylene particles, a presence rate of the polytetrafluoroethylene particles having a primary particle diameter of 150 nm or less is 10% or more, and
in the polytetrafluoroethylene particles, a presence rate of the polytetrafluoroethylene particles having a primary particle diameter of 250 nm or more is 5% or less.

4. The image forming method according to claim 1, wherein
the fluorine-containing resin particles are polytetrafluoroethylene particles,
the polytetrafluoroethylene particles have a number-average molecular weight of 12,000 or more and 20,000 or less.

5. The image forming method according to claim 1, wherein
a content rate of the unit A1 is 20.0 mass % or more with respect to the mass of the resin A.

6. The image forming method according to claim 1, wherein
a content rate of the resin A is 40.0 mass % or more with respect to the mass of the toner particles.

7. The image forming method according to claim 1, wherein
the toner has a softening point of 70° C. or more and 120° C. or less.

8. The image forming method according to claim 1, wherein
the electrophotographic photoreceptor includes a support, a charge generation layer on the support, and a charge transport layer on the charge generation layer, and
the charge transport layer is the surface layer.

9. The image forming method according to claim 1, wherein
the electrophotographic photoreceptor includes a support, a charge generation layer on the support, a charge transport layer on the charge generation layer, and a protective layer on the charge transport layer, and
the protective layer is the surface layer.

10. A process cartridge attachable to and detachable from an electrophotographic apparatus main body, wherein
the process cartridge integrally supports at least one device selected from the group consisting of a charging device, an exposing device, a developing device, a transferring device, and a cleaning device,
the process cartridge includes a toner and an electrophotographic photoreceptor,
the toner contains toner particles,
the toner particles contain a resin A including a unit A1 represented by formula (1): 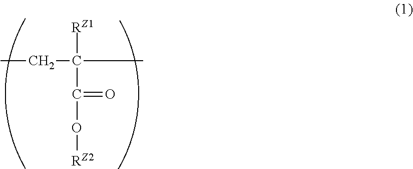
in the formula (1), R^{Z1} represents a hydrogen atom or a methyl group; and R^{Z2} represents an alkyl group having 18 to 36 carbon atoms,
the electrophotographic photoreceptor includes a surface layer containing:
(i) fluorine-containing resin particles; and
(ii) a fluorine-based polymer B including a unit B1 represented by formula (2) and a unit B2 represented by formula (3): 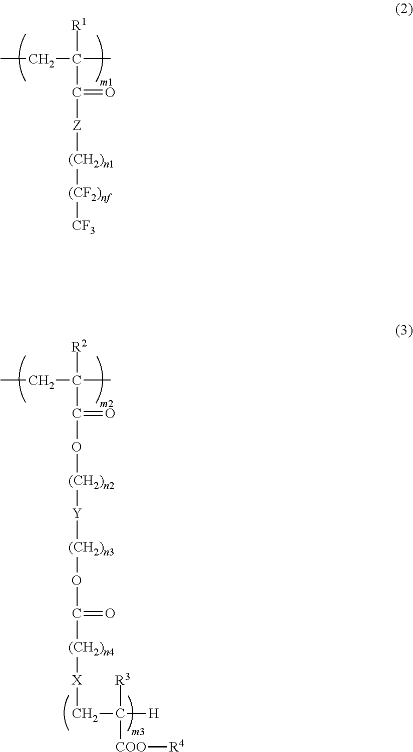
in the formulae (2) and (3), R¹, R², R³, and R⁴ each independently represent a hydrogen atom or an alkyl group; X represents an alkylene group, a halogen-substituted alkylene group, —S—, —O—, —NH—, or a single bond; Y represents an alkylene group, a halogen-substituted alkylene group, an alkylene group including a hydroxy group, or a single bond; Z represents —O— or —NH—; m1, m2, and m3 each independently represent an integer of 1 or more: n1, n2, n3, and n4 each independently represent an integer of 0 or more; and of represents an integer of 1 to 5.

11. An image forming apparatus comprising a charging device, an exposing device, a developing device, a transferring device, a fixing device, and a cleaning device, wherein
the image forming apparatus includes a toner and an electrophotographic photoreceptor,
the toner contains toner particles,
the toner particles contain a resin A including a unit A1 represented by formula (1): 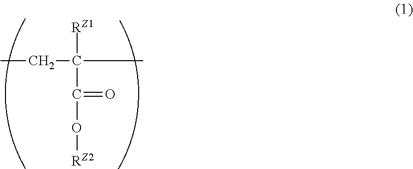
in the formula (1), R^{Z1} represents a hydrogen atom or a methyl group; and R^{Z2} represents an alkyl group having 18 to 36 carbon atoms,
the electrophotographic photoreceptor includes a surface layer containing:
(i) fluorine-containing resin particles; and
(ii) a fluorine-based polymer B including a unit B1 represented by formula (2) and a unit B2 represented by formula (3): 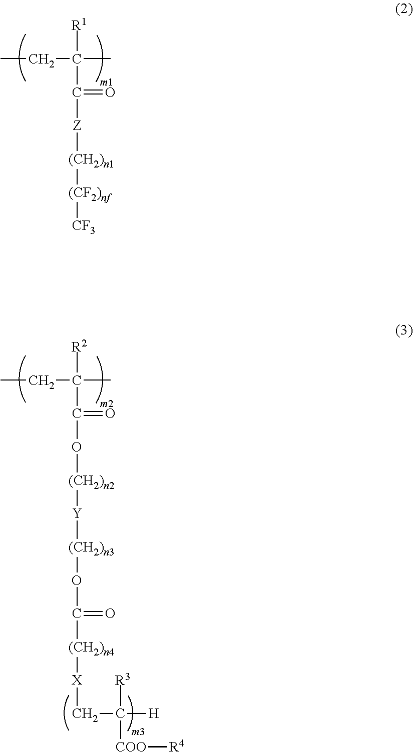
in the formulae (2) and (3), R¹, R², R³, and R⁴ each independently represent a hydrogen atom or an alkyl group; X represents an alkylene group, a halogen-substituted alkylene group, —S—, —O—, —NH—, or a single bond; Y represents an alkylene group, a halogen-substituted alkylene group, an alkylene group including a hydroxy group, or a single bond; Z represents —O— or —NH—; m1, m2, and m3 each independently represent an integer of 1 or more; n1, n2, n3, and n4 each independently represent an integer of 0 or more; and of represents an integer of 1 to 5.
